(19) United States
(12) Patent Application Publication
(10) Pub. No.: US 2025/0267458 A1
(43) Pub. Date: Aug. 21, 2025

(54) PREVENTING EXTERNAL ENTITIES FROM PROVIDING LOCATION SERVICES USING PRIVATE ESL SYSTEMS

(71) Applicant: QUALCOMM Incorporated, San Diego, CA (US)

(72) Inventors: Varun Amar Reddy, San Diego, CA (US); Sony Akkarakaran, Poway, CA (US)

(21) Appl. No.: 18/442,967

(22) Filed: Feb. 15, 2024

(51) Int. Cl. H04W 12/104; H04W 12/03

(52) U.S. Cl. CPC H04W 12/104; H04W 12/03

(57) ABSTRACT

This disclosure provides systems, methods, and devices for Electronic Shelf Label (ESL) systems that support secure ESL position determination. In a first aspect, a device for wireless communication includes at least one processor and a memory coupled to the at least one processor. The at least one processor is configured to cause the device to: obtain configuration information for position determination; receive, from an electronic shelf label (ESL) access point (AP), a beacon start transmission including address generation information; generate, using encryption information, encrypted address information based on stored device specific information, the configuration information, and the address generation information; and transmit the encrypted address information, the encrypted address information corresponding to a dynamic encrypted address, the encrypted address information configured to enable secure position determination. Other aspects and features are also claimed and described.

### TECHNICAL FIELD

Aspects of the present disclosure relate generally to wireless communication systems, and more particularly, to electronic shelf label (ESL) systems. Some features may enable and provide improved communications and network security, including secure positioning determination for ESL systems.

### INTRODUCTION

In general, retail stores use paper labels to display information about products displayed on shelves, such as prices, discount rates, unit costs, origins, or the like. Using such paper labels for the price display has limitations. For example, when there are changes in product information or locations on shelves, the retailer must generate new paper labels and discard old ones. This raises costs for maintenance in both supplies and employee labor. Further, in environmental terms, replacing the labels wastes raw materials such as paper, which adversely affects the protection of the environment. Still further, humans are prone to make mistakes, such as mislabeling a shelf or product or forgetting to take down temporary price changes on certain shelving, which results in shopper frustration.

Electronic shelf label (ESL) devices are electronic devices for displaying price information for items on retail store shelves, which may be used in place of paper labels. ESL devices may be attached to a front edge of retail shelving and display a variety of pricing information using display devices, such as Liquid Crystal Displays (LCD). Whenever the information about a product or the location of a product is changed, the ESL device may be programmed with new product information. Thus, the electronic shelf label can be repeatedly used.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

Electronic shelf label (ESL) devices may be used in a wireless network to provide information and services to shoppers and retailers (as users of an ESL system). For example, ESL devices operating on a wireless network as part of ESL system may support position location services to identify the location of ESLs devices within an environment (e.g., a retail store). As another example, the ESL system may support position location services to identify a position of users within the environment by interacting with the user's mobile device. Example embodiments provide for secure ESL position determinations which enable position determination for and optionally by non-ESL devices which do not comprise ESL network integrity.

In one aspect of the disclosure, a device includes at least one processor and a memory coupled to the at least one processor. The at least one processor is configured to cause the device to: receive, from an electronic shelf label (ESL) server, configuration information for position determination; receive, from the ESL server, address generation information; generate, address information based on the address generation information and the configuration information; and transmit, to one or more ESL radios, a beacon start transmission including the address information, the beacon start transmission configured to cause one or more ESL devices to generate a corresponding encrypted dynamic address based on the address generation information and transmit a beacon indicating the corresponding encrypted dynamic address.

In an additional aspect of the disclosure, a device includes at least one processor and a memory coupled to the at least one processor. The at least one processor is configured to cause the device to: obtain configuration information for position determination; receive, from an electronic shelf label (ESL) access point (AP), a beacon start transmission including address generation information; generate, using encryption information, encrypted address information based on stored device specific information, the configuration information, and the address generation information; and transmit the encrypted address information, the encrypted address information corresponding to a dynamic encrypted address, the encrypted address information configured to enable secure position determination.

In an additional aspect of the disclosure, a device includes at least one processor and a memory coupled to the at least one processor. The at least one processor is configured to cause the device to: transmit configuration information for dynamic address configuration for electronic shelf label (ESL) devices; transmit, to an ESL access point (AP), address generation information; generate address mapping information based on the configuration information and the address generation information; and transmit the address mapping information to a UE, the mapping information including ESL position information for ESL devices and corresponding dynamic address information for the ESL devices.

In an additional aspect of the disclosure, a device includes at least one processor and a memory coupled to the at least one processor. The at least one processor is configured to cause the device to: transmit configuration information for dynamic address configuration for electronic shelf label (ESL) devices; transmit, to an ESL access point (AP), address generation information; generate address mapping information based on the configuration information and the address generation information; and transmit the address mapping information to a UE, the mapping information including ESL position information for ESL devices and corresponding dynamic address information for the ESL devices.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

Devices, networks, and systems may be configured to communicate via one or more portions of the electromagnetic spectrum. The present disclosure describes certain aspects with reference to certain communications technologies, such as Bluetooth or Wi-Fi. However, the description is not intended to be limited to a specific technology or application, and one or more aspects described with reference to one technology may be understood to be applicable to another technology. Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus, and methods described herein may be applied to other communications systems and applications than the particular examples provided.

For example, the described implementations may be implemented in any device, system, or network that is capable of transmitting and receiving RF signals according to any of the wireless communication standards, including any of the IEEE 802.11 standards, the IEEE 802.15.1 Bluetooth® standards, Bluetooth low energy (BLE), code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, 5G New Radio (5G NR), 6G, or other known signals that are used to communicate within a wireless, cellular, or internet of things (IoT) network, such as a system utilizing 3G, 4G 5G, or 6G technology, or further implementations thereof.

In various implementations, the techniques and apparatus may be used in wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5th Generation (5G) or new radio (NR) networks (sometimes referred to as “5G NR” networks, systems, or devices), as well as other communications networks. As described herein, the terms “networks” and “systems” may be used interchangeably and may refer to a collection of devices capable of communicating with each other through one or more communications techniques.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, or packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.).

Implementations may range from chip-level or modular components to non-modular, non-chip-level implementations and further to aggregated, distributed, or original equipment manufacturer (OEM) devices or systems incorporating one or more described aspects. In some settings, devices incorporating described aspects and features may also include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, or constitutions.

In the following description, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well-known circuits and devices are shown in block diagram form to avoid obscuring teachings of the present disclosure.

Some portions of the detailed descriptions which follow are presented in terms of procedures, logic blocks, processing, and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

In the figures, a single block may be described as performing a function or functions. The function or functions performed by that block may be performed in a single component or across multiple components, and/or may be performed using hardware, software, or a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory, and the like.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling,” “generating” or the like, refer to the actions and processes of a computer system, or similar electronic computing device, that manipulates and transforms data represented as physical (electronic) quantities within the computer system's registers and memories into other data similarly represented as physical quantities within the computer system's registers, memories, or other such information storage, transmission, or display devices.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the below description and examples use the term “device” to describe various aspects of the disclosure, the term “device” is not limited to a specific configuration, type, or number of objects. As used herein, an apparatus may include a device or a portion of the device for performing the described operations.

As used herein, including in the claims, the term “or,” when used in a list of two or more items, means that any one of the listed items may be employed by itself, or any combination of two or more of the listed items may be employed. For example, if a device is described as containing components A, B, or C, the device may contain A alone; B alone; C alone; A and B in combination; A and C in combination; B and C in combination; or A, B, and C in combination.

Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof.

Also, as used herein, the term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

Also, as used herein, relative terms, unless otherwise specified, may be understood to be relative to a reference by a certain amount. For example, terms such as “higher” or “lower” or “more” or “less” may be understood as higher, lower, more, or less than a reference value by a threshold amount.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating an example Electronic Shelf Label (ESL) system according to some embodiments of this disclosure.

FIG. 2A is a perspective view of a gondola with Electronic Shelf Label (ESL) devices according to some embodiments of the disclosure.

FIG. 2B is a top-down view of a retail environment with Electronic Shelf Label (ESL) devices accessible to a user according to some embodiments of the disclosure.

FIG. 3 is a timing diagram illustrating time division multiplexing for communicating with multiple Electronic Shelf Label (ESL) devices according to some embodiments of the disclosure.

FIG. 4 is a block diagram illustrating an example ESL device according to some embodiments of this disclosure.

FIG. 5 is a block diagram illustrating an example wireless communication system that supports enhanced ESL position determination and ESL position based notifications according to one or more aspects.

FIG. 6 is a timing diagram illustrating an example process that supports enhanced ESL position determination and ESL position based notifications according to one or more aspects.

FIG. 7 is a timing diagram illustrating an example process that supports enhanced ESL position determination and ESL position based notifications according to one or more aspects.

FIG. 8 is a timing diagram illustrating an example process that supports enhanced ESL position determination and ESL position based notifications according to one or more aspects.

FIG. 9 is a diagram illustrating an example of Bluetooth message and information element formats.

FIG. 10 is a flow diagram illustrating an example process that supports secure ESL position determination operations according to one or more aspects.

FIG. 11 is a flow diagram illustrating another example process that supports enhanced ESL position determination according to one or more aspects.

FIG. 12 is a flow diagram illustrating another example process that supports secure ESL position determination operations according to one or more aspects.

FIG. 13 is a flow diagram illustrating another example process that supports secure ESL position determination operations according to one or more aspects.

FIG. 14 is a block diagram of an example UE that supports secure ESL position determination operations according to one or more aspects.

FIG. 15 is a block diagram of an example ESL device that supports secure ESL position determination operations according to one or more aspects.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support enhanced Electronic Shelf Label (ESL) position determination and ESL position based notification operations. The enhanced ESL position determination operations support secure determination of device position within an ESL system based on ESL infrastructure, including for non-ESL devices. The enhanced, secure ESL position determination operations may enable ESL devices or non-ESL devices (e.g., UEs) to determine a position for the non-ESL devices based on ESL wireless transmissions. The ESL determined position may then be used to determine and/or transmit notifications which enable automated monitoring of the ESL system and products thereof, and enable improved or additional functionality for users or ESL systems including improved automated task completion.

Particular implementations of the subject matter described in this disclosure may be implemented to realize one or more of the following potential advantages or benefits. In some aspects, the present disclosure provides techniques for secure, dynamic address generation for wireless communication systems that may be particularly beneficial in secure ESL applications. For example, the ESL position based determination enables devices of the ESL and outside devices within a range of the ESL to determine a position of itself or ESL devices or assets based on existing ESL transmissions without enabling outside devices to map the ESL devices or system over time. Thus, position of devices and assets can be securely determined without additional power consumption, complexity, or signaling overhead, and without compromise of ESL integrity. As another example, the ESL notifications based on the ESL determined positions enable automated asset monitoring and notification generation (e.g., asset misplaced, moved, stolen, etc.) and enable guidance of users and robots within the ESL system. In some such aspects, the ESL system may be able to further configure the ESLs of the system to provide visual or audio clues to help users or robots complete tasks or locate a product.

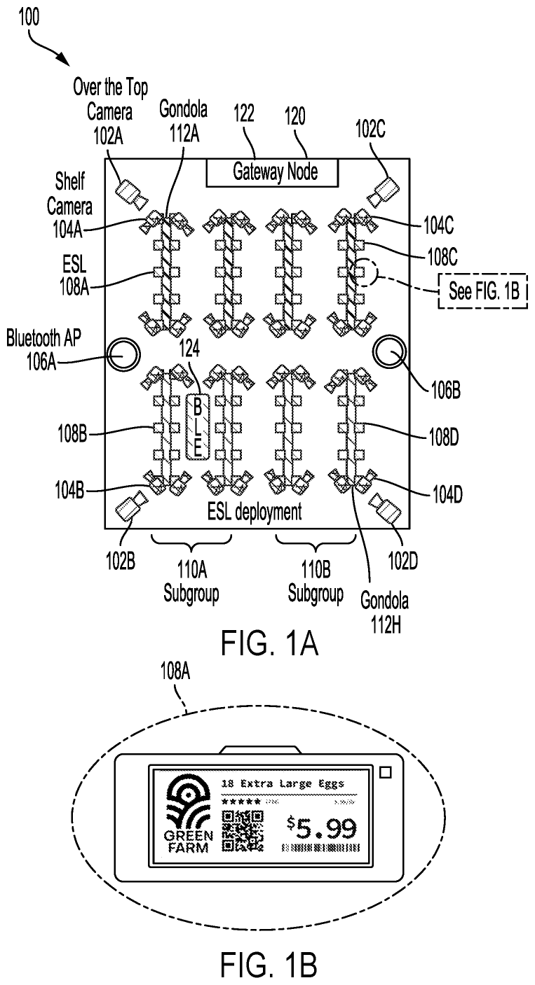

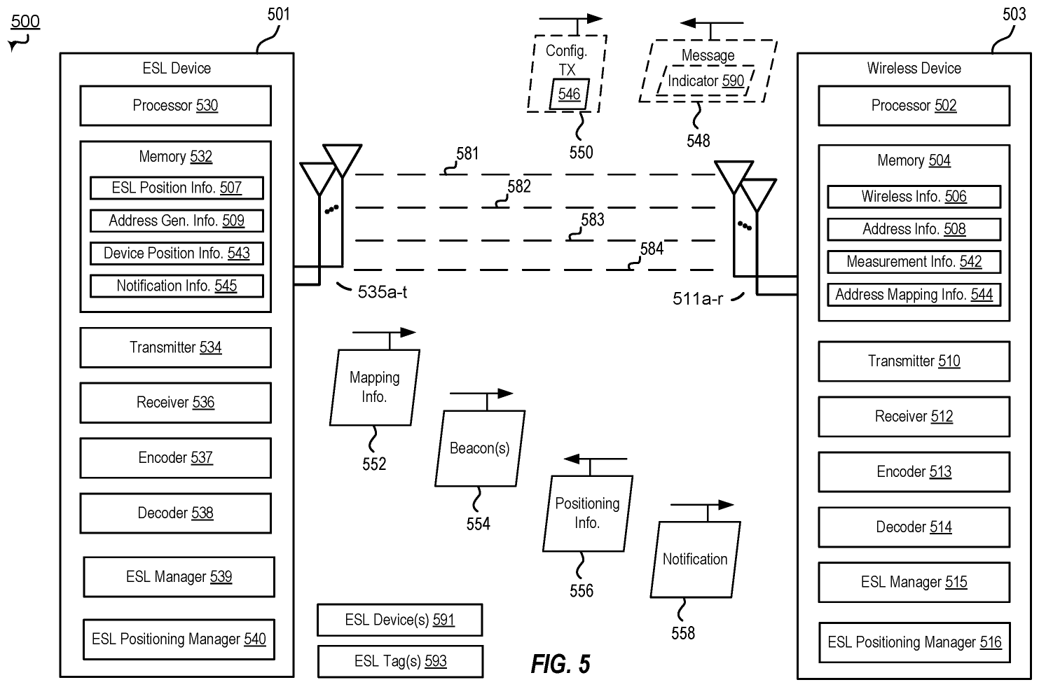

FIG. 1 is a block diagram illustrating an example Electronic Shelf Label (ESL) system according to some embodiments of this disclosure. An electronic shelf label (ESL) system 100 may include a management server 122 that is integrated with or coupled to a gateway node 120. The management server 122 may include at least one processor coupled to a memory, in which the at least one processor is configured to execute computer program code stored on a computer-readable medium to cause the management server 122 to perform operations related to managing operation of the ESL devices 108A-D, the APs 106A-106B, the gateway node 120, and/or other components within the ESL system 100. For example, the management server 122 may perform operations relating to secure ESL based position determination and/or generation of ESL notifications based on ESL based position determinations. For example, the management server 122 may perform operations described with reference to FIGS. 5-8.

The gateway node 120 may communicate with access point (AP) 106A and access point (AP) 106B. Although only two APs are shown in the example system, fewer or more APs may be included in the ESL system 100. The APs 106A and 106B may communicate through a first communication network, either wired or wireless, with the gateway node 120. The APs 106A and 106B also communicate through a second communication network with Electronic Shelf Label (ESL) tag devices. For example, the APs 106A and 106B may communicate with paired ESL devices in an assigned geographic area. In a first geographic assignment 110A, the AP 106A may communicate with ESL device 108A and ESL device 108B; in a second geographic assignment 110B, the AP 106B may communicate with ESL device 108C and ESL device 108D. The first and second communication networks may be different networks. In some embodiments, the first communication network for communication between AP 106A and gateway node 120 is a Wi-Fi network and the second communication network for communication between AP 106A and ESL device 108A is a Bluetooth network.

Bluetooth technology provides a secure way to connect and exchange information between electronic devices, such as smartphones, other cellular phones, headphones, earbuds, smartwatches, laptops, wearables, and/or shelf labels. Bluetooth communications may include establishing wireless personal area networks (PANs) (also referred to as “ad hoc” or “peer-to-peer” networks). These ad hoc networks are commonly called “piconets.” Each device may belong to multiple piconets. Multiple interconnected piconets may be called scatternets. A scatternet may be formed when a member of a first piconet elects to participate in a second piconet. In the example of FIG. 1, the ESL device 108A may be in a piconet with the AP 106A.

Because many of the services offered over Bluetooth can expose private data or allow the connecting party to control the connected device, Bluetooth networks may have devices first establish a “trust relationship” before they are allowed to communicate private data to one another. This trust relationship may be established using a process referred to as “pairing,” in which a bond is formed between two devices. This bond enables the devices to communicate with each other in the future without further authentication. The ESL device 108A may be bonded in such a manner to the AP 106A. The pairing process may be triggered automatically each time the device is powered on or moved within a certain distance of another Bluetooth device. Pairing information relating to current and previously established pairings may be stored in a paired device list (PDL) in the memory of the Bluetooth device, such as the ESL device 108A and/or the AP 106A. This pairing information may include a name field, an address field, a link key field, and other similar fields (such as “profile” type) useful for authenticating the device or establishing a Bluetooth communication link. The pairing information may allow the ESL device 108A to reconnect to the AP 106A automatically when, for example, power loss causes the ESL system 100 to reset.

A Bluetooth “profile” describes general behaviors through which Bluetooth-enabled devices communicate with other Bluetooth devices. For example, the hands free profile (HFP) describes how a Bluetooth device (such as a smartphone) may place and receive calls for another Bluetooth device, and the Advanced Audio Distribution Profile (A2DP) describes how stereo-quality audio may be streamed from a first Bluetooth device (such as a smartphone) to another Bluetooth device (such as an earbud). The ESL devices 108A-108D may be configured with an Electronic Shelf Label Profile compliant with the Electronic Shelf Label Profile v1.0 dated Mar. 28, 2023, which is incorporated by reference herein. The ESL Profile may specify how the AP 106A may use one or more ESL Services exposed by the ESL device 108A.

The management server 122 may be implemented as a database (DB) server that stores and manages product information regarding products displayed in a distribution store. The management server 122 may store a variety of information used during the operation of a store, as well as product information. Furthermore, the management server 122 may write and manage command messages that are used to carry out various functions such as the synchronization, updating, and alteration of product information displayed on the ESL devices 108A-108D. The management server 122 may be provided with a database for the ESL devices 108A-108D and product information displayed on the ESL devices 108A-108D. That is, the management server 122 may be provided with a database that stores identification information relating to ESL devices 108A-108D in connection with product information displayed on a corresponding one of the ESL devices 108A-108D.

A command message, created by the management server 122 (e.g., a product-information change message or a management-information acquisition message) can be transferred to the gateway node using a message packaged into a packet suitable for a communication scheme used with the gateway node 120, and transfer the configured packet. Furthermore, the management server 122 may receive a reception acknowledgement message, sent from the gateway node 120, through the communication scheme, convert the received message into a message receivable by the management server 122, and transfer the converted message. The messages may include notifications of an ESL system determination position and/or notification instructions based on ESL determined positions as described further with reference to FIGS. 5-8.

Although only one gateway node 120 is shown in the ESL system 100, there may be several such gateway nodes communicating with the management server 122. Each gateway node 120 analyzes data received from the management server 122 confirming the presence or absence of a message or data, which is to be sent to the ESL device 108A, and then sends the confirmed message or data to the corresponding ESL device 108A. The gateway node 120 may configure a message, which is to be sent to the ESL device 108A, into a packet according to a communication scheme and send the configured packet to the ESL device 108A through commanding the AP 106A to transmit the packet. Furthermore, the gateway node 120 may transfer a reception acknowledgement message received from the ESL device 108A through the AP 106A to the management server 122.

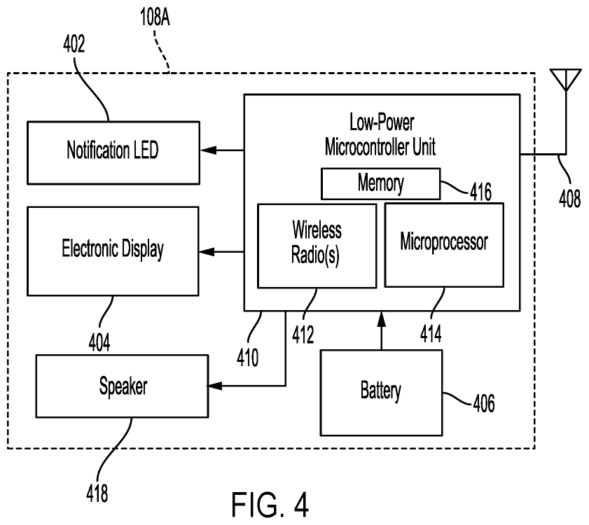

The ESL devices 108A-108D may include a plurality of ESL devices 108A-108D displaying data concerning product information received from the gateway node 120. The ESL devices 108A-D displaying product information associated with products may be attached to the shelving. One example layout of an ESL system 100 is shown across multiple gondolas 112A-112H. Each of the gondolas 112A-112H may include one or more shelves, to which the ESL devices 108A-108D are attached. The ESL device 108A-108D may be configured as shown, for example, in FIG. 4, with the microcontroller configured to perform operations described with reference to FIG. 5-8, 10, or 11.

In some embodiments, a video monitoring system may be included as part of ESL system 100 or used to augment the capabilities of the ESL system 100. For example, shelf cameras 104A-104D may be positioned with a field of view that captures one or more shelves of one or more of the gondolas 112A-112H. The shelf cameras 104A-104D may be used to assist in tracking stock levels and/or identifying items picked by users while in the environment. As another example, over-the-top (OTT) cameras 102A-102D may be positioned with a field of view capturing large regions of an environment of the ESL system 100. Object recognition systems may be applied to received image frames from the cameras 102A-D or 104A-D to determine a presence of, or count of, objects and humans in the field of view of a respective camera.

The OTT cameras 102A-102D may be used to support determination of a position of an ESL device 108A-D, user mobile device, or other devices within the environment. A mobile device supporting Bluetooth Low Energy (BLE), such as BLE device 124, may traverse the environment and communicate with the ESL devices 108A-108D, for example to receive identification information from the ESL devices 108A-108D, with the location of the ESL devices 108A-D determined by identifying a location of the BLE device 124 from the camera image frames at the time the BLE device 124 receives signals, and/or the strength of the signals, received from the ESL devices 108A-108D.

The ESL devices 108A-108D may change price information or be activated or inactivated while communicating with the gateway node 120. A store manager may send the management server 122 a command concerning the synchronization between a product and the ESL device 108A and/or a command for the correction of information regarding a product assigned to the ESL device 108A. An example ESL device display is shown inset in the FIG. 1, with such a device displaying information including a product description, a product image, a product price, a product barcode, a product rating, a product Stock Keeping Unit (SKU), and/or a product link (e.g., a URL or QR code).

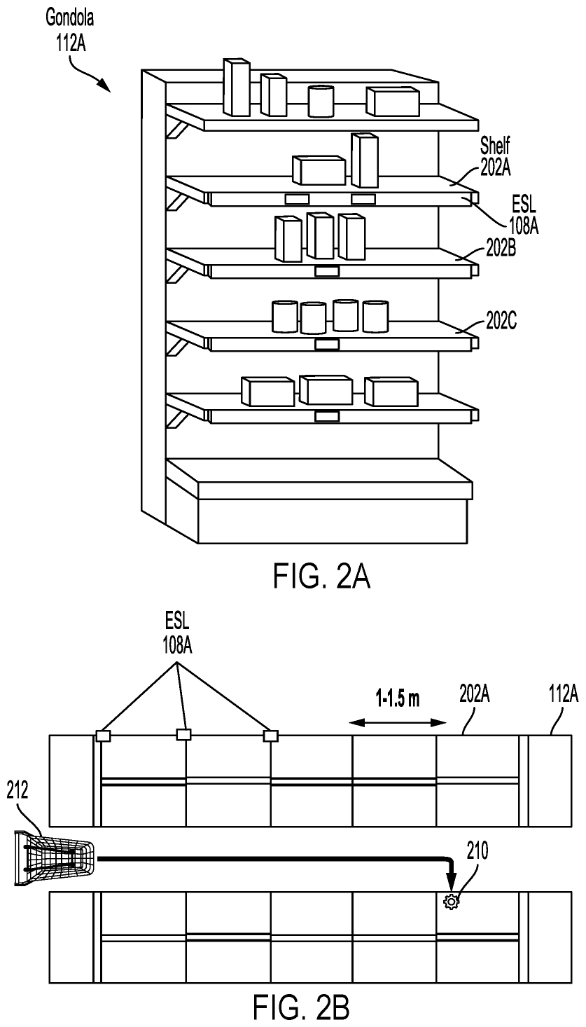

As described earlier, the environment may include ESL devices organized on gondolas and shelves. One example illustration of such an arrangement is shown in FIG. 2A. FIG. 2A is a perspective view of a gondola with Electronic Shelf Label (ESL) devices according to some embodiments of the disclosure. The gondola 112A may include multiple shelves 202A-202C at different vertical levels from a floor. ESL devices may be attached to the shelves 202A-202C. For example, ESL device 108A may be attached to shelf 202A to display information regarding products stocked on shelf 202A in the vicinity of the ESL device 108A.

The ESL devices may provide information to a shopper or store employee operating in the environment, such as to provide information regarding products and/or assist with location determination of products or the user. FIG. 2B is a top-down view of a retail environment with Electronic Shelf Label (ESL) devices accessible to a user according to some embodiments of the disclosure. A user pushing a shopping cart 212 through an aisle may use ESL devices to determine the location of a particular product. For example, a mobile device associated with the shopping cart 212 may guide a user to location 210 where stock for a desired product is located.

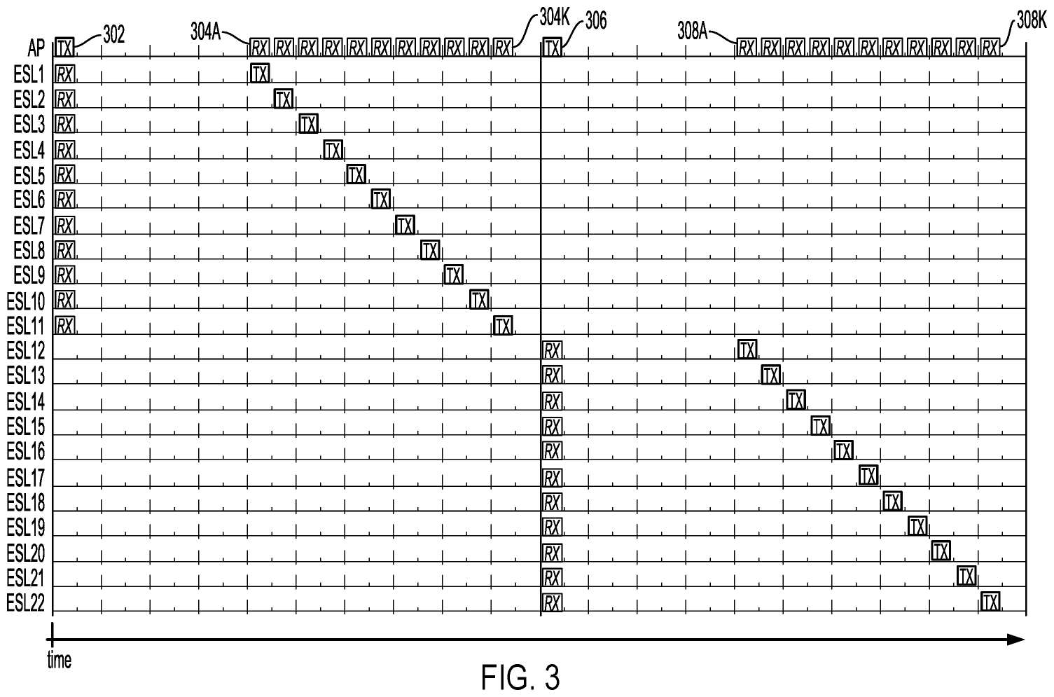

Communication within the ESL system 100 between an access point (AP) and Electronic Shelf Label (ESL) devices may be performed according to a Time Division Multiple Access (TDMA) scheme, such as one illustrated in FIG. 3. FIG. 3 is a timing diagram illustrating time division multiplexing for communicating with multiple Electronic Shelf Label (ESL) devices according to some embodiments of the disclosure. An AP, such as AP 106A, may broadcast information that is received by all ESL devices, including ESL device 108A, during a first time period 302. The ESL devices may communicate with the AP during subsequent time periods. For example, a first ESL device, such as ESL device 108A, may transmit in time period 304A, with other ESL devices transmitting in time periods 304B-304K. In ESL systems with significant numbers of ESL devices, the ESL devices may be configured to communicate in different groups. For example, ESL devices 1-11 may be configured to transmit to the AP during a first time cycle and ESL devices 12-22 may be configured to transmit to the AP during a second time cycle. The first and second time cycles may alternate during operation of the wireless network.

An ESL device may include components configured together to provide some or all of the functionality described in this disclosure and/or provide additional functionality. FIG. 4 is a block diagram illustrating an example Electronic Shelf Label (ESL) device according to some embodiments of this disclosure. The ESL device 108A may include a low-power microcontroller 410. Although functionality for the ESL device may be configured by the microcontroller 410 in embodiments of this disclosure, any single or combination of processors (e.g., at least one processor) may be used to perform the functions described according to embodiments of this disclosure.

The microcontroller 410 may include a memory 416. The memory 416 may store computer program code that causes a microcontroller 410 to execute operations that carry out some or all of the functionality described in embodiments of this disclosure. Although shown as part of the microcontroller 410, the memory 416 may be located internal to or external to the microcontroller 410. The microcontroller 410 may also include one or more wireless radio(s) 412. The wireless radios 412 may include, for example, a Bluetooth wireless radio including a front end that couples to antenna 408 for transmitting and receiving radio frequency (RF) signals at one or more frequencies in one or more frequency bands. In some embodiments, the microcontroller 410 is a System on Chip (SoC) in which two or more components of the wireless radio(s) 412, the microprocessor 414, and/or the memory 416 are included in a single semiconductor package. In some embodiments, the two or more components may be included on a single semiconductor die.

The ESL device 108A may include I/O devices, such as a notification LED 402 and/or an electronic display 404. The notification LED 402 may include one or more light emitting diodes (LEDs), or other light sources configured to flashlight of one or more colors. The notification LED may be triggered to blink at a specific time and/or with a specific color based on a command received from the gateway node 120. For example, a notification LED 402 may blink to attract a user's attention to a particular location on a shelf. The electronic display 404 may be, for example, an electronic-ink (e-Ink) display configured to output the product information. In some implementations, the ESL device 108A may include a speaker 418. The speaker 418 may include one or more audio output devices configured to output audio signals. For example, the speaker 418 may output tones, beeps, bell or chime sounds, or speech.

The ESL device 108A may couple to a battery 406 or other power source to power operations performed by the ESL device 108A, such as to operate the wireless radio(s) 412, the notification LED 402, the electronic display 404, the memory 416, the speaker 418, and/or the microprocessor 414. The battery 406 may allow placement of the ESL device 108A in a place where constant power supply is difficult. Thus, in order that a single battery charge provides a long period of use (e.g., lasting longer than several years), the ESL device 108 may be configured to reduce power consumption during times when frequent commands are not expected. For example, the ESL device 108A may operate using a wakeup communication scheme. That is, the ESL device 108A wakes up according to predetermined time intervals to determine whether data is waiting to be received. When no data is waiting, power to the ESL device 108A is turned off until the next wakeup period to reduce power consumption. When there is data to be received, the ESL device 108A wakes up to perform communication operations.

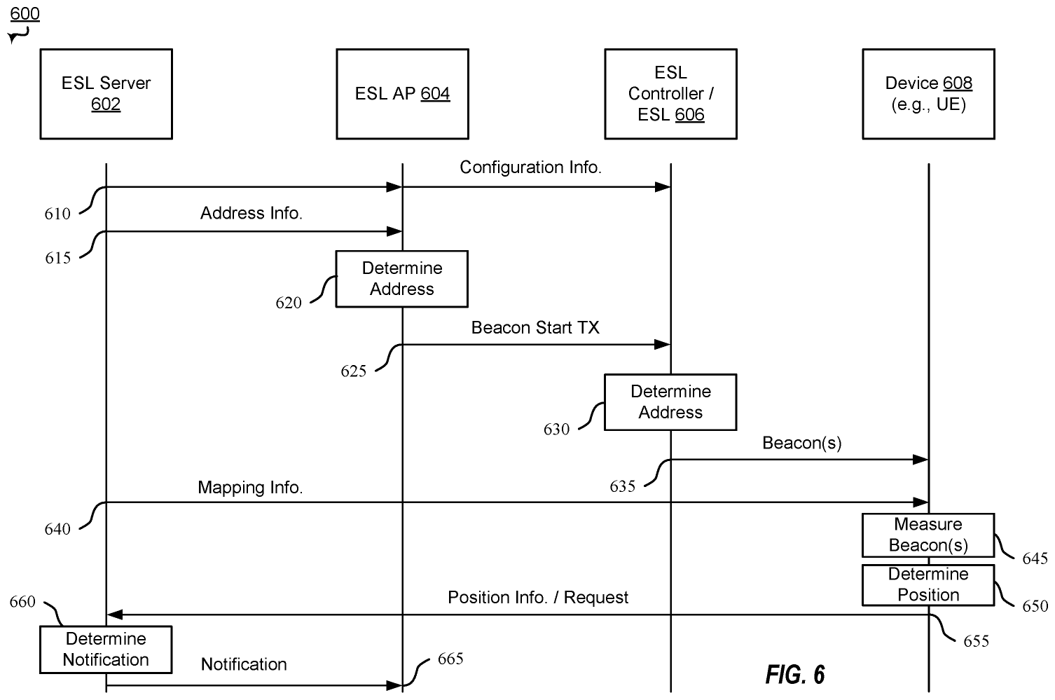

It is noted that one or more blocks (or operations) described with reference to FIGS. 1-4 may be combined with one or more blocks (or operations) described with reference to another of the figures. For example, one or more blocks (or operations) of FIG. 5 may be combined with one or more blocks (or operations) of FIGS. 1-4. As another example, one or more blocks associated with FIG. 6 may be combined with one or more blocks associated with FIGS. 1-4.

In wireless communication, such as Bluetooth, devices are identified using a device address and an address type. The address type indicates either a public device address or a random device address. As an example, for Bluetooth a public device address and a random device address are both 48 bits in length. A device shall use at least one type of device address and may use both. The device may be addressed by a transmitting device that uses any device address that it uses. Thus, a device's Identity Address is a Public Device Address or Random Static Device Address that it uses in packets it transmits.

The public device address is a static unique identifier, that is often related to the MAC address of the device. Hence, a public address will always remain static and cannot be randomized. The random device address (e.g., a dynamic address) may either be a semi-static address or a private address. The semi-static address may be a 48-bit randomly generated address that can be assigned a new value after each power cycle. The private address may be a 48-bit randomly generated address using Advanced Encryption Standard (AES)-128 encryption that requires both the transmitter and the receiver to have knowledge of a private key.

Random addresses may be utilized by ESL devices to provide for secure ESL positioning operations. The addresses will be dynamic and will only remain “static” for a short period of time, such as for a single transmission. The ESL device can be treated to be ‘power-cycled’ every duty cycle, such as described in FIG. 3. Thus, the ESL radio broadcasts a unique address every time it wakes up to transmit a beacon start or beacon transmission, creating an ESL system which uses private addresses that are random and dynamic. By utilizing such addresses for ESL operations, ESL positioning operations can be secured against external entities.

FIG. 5 illustrates an example of a wireless communications system 500 that supports enhanced ESL position determination and ESL position based notification operations in accordance with aspects of the present disclosure. In some examples, the wireless communications system 500 may implement aspects of ESL system 100. For example, the wireless communications system 500 may include an ESL network, such as ESL infrastructure including one or more ESL devices or network entities, and one or more wireless devices which interact with the ESL infrastructure. The wireless devices may include UEs, such as UE 115. As illustrated in the example of FIG. 5, the wireless communications system 500 includes an ESL device 501 and a wireless device 503.

The ESL device 501 may include or correspond to any of the ESL devices or infrastructure described herein, including the gateway node 120, the management server 122, an ESL AP (e.g., the AP 106A or 106B), an ESL device or controller (e.g., ESL devices 108C or 108D), or the ESL device 400 of FIG. 4. An ESL controller may include one or more ESL devices and a wireless radio and be referred to as an ESL rail controller.

The wireless device 503 may include or correspond to a UE that interacts with ESL infrastructure, or to a second ESL device. The UE may be part of the ESL infrastructure or separate from the ESL infracted. For example, the UE may be associated with a worker or a robot, or with a customer/shopper. The second ESL device may include any of the ESL devices of ESL device 501 and may include or correspond to a different type of ESL device from the ESL device 501. As illustrative, non-limiting examples, the ESL device 501 may include or correspond to an ESL controller associated with one or more ESLs and the wireless device 503 may include or correspond to an ESL AP, an ESL server, or an IoT tag associated with a product or asset of the ESL network.

As illustrated in the example of FIG. 5, the wireless communications system 500 may further include one or more ESL devices 591 (e.g., second ESL devices), one or more ESL tags 593 (e.g., IoT tags). The one or more ESL devices 591 may include or correspond to an ESL device which is the same type as or a different type from a type of the ESL device 501, a type of the wireless device 503, or both. The ESL tags 593 may include or correspond to passive or battery-less radios which may output a signal or beacon based on received RF energy. The ESL tags 593 may be coupled to or associated with one or more products or assets of the ESL system. In a particular implementation, the one or more ESL devices 591 may include an energizer device configured to provide RF energy to the ESL tags 593 and/or trigger the ESL tags 593 to broadcast beacons for measurement.

Enhanced ESL position determination and ESL position based notification operations may provide additional functionality for the ESL network and devices which interact with the ESL network. For example, enhanced ESL position determination may enable increased positional accuracy and lower power consumption for determining positions of devices and assets within an ESL network. Additionally, the enhanced ESL position determination may enable enhanced ESL position based notification which can help automate tasks and/or assist in tasks related to operation and maintenance of the ESL network. Accordingly, ESL network and device performance can be increased.

ESL device 501 and wireless device 503 may be configured to communicate via one or more portions of the electromagnetic spectrum. For example, the ESL device 501, the wireless device 503, or both, may be configured to communicate via one or more portions of the electromagnetic spectrum associated with Bluetooth transmissions, Wi-Fi transmissions, or cellular transmissions (including sub-6 GHz and 6 GHz).

ESL device 501 and wireless device 503 may be configured to communicate via one or more channels or component carriers (CCs), such as representative first channel 581, second channel 582, third channel 583, and fourth channel 584. Although four channels are shown, this is for illustration only, more or fewer than four channels may be used. One or more channels may be used to communicate control channel transmissions, data channel transmissions, and/or sidelink channel transmissions.

Each channel or CC may have a corresponding configuration, such as configuration parameters/settings. The configuration may include bandwidth, bandwidth part, HARQ process, TCI state, RS, control channel resources, data channel resources, or a combination thereof. Additionally, or alternatively, one or more channels or CCs may have or be assigned to a Cell ID, or a Bandwidth Part (BWP) ID. The Cell ID may include a unique cell ID for the channel or CC, a virtual Cell ID, or a particular Cell ID of a particular channel or CC of the plurality of channels or CCs. Additionally, or alternatively, one or more channels or CCs may have or be assigned to a HARQ ID. Each channel or CC may also have corresponding management functionalities, such as, beam management or BWP switching functionality. In some implementations, two or more channels or CCs are quasi co-located, such that the channels or CCs have the same beam and/or same symbol.

In some implementations, control information may be communicated via ESL device 501 and wireless device 503. For example, the control information may be communicated using Bluetooth transmissions, Wi-Fi transmission, MAC-CE transmissions, RRC transmissions, DCI (downlink control information) transmissions, UCI (uplink control information) transmissions, SCI (sidelink control information) transmissions, another transmission, or a combination thereof.

Wireless device 503 can include a variety of components (e.g., structural, hardware components) used for carrying out one or more functions described herein. For example, these components can include processor 502, memory 504, transmitter 510, receiver 512, encoder, 513, decoder 514, ESL manager 515, ESL positioning manager 516, and antennas 511a-r. Processor 502 may be configured to execute instructions stored at memory 504 to perform the operations described herein. In some implementations, processor 502 includes or corresponds to the microcontroller unit 410 and/or the microprocessor 414 of FIG. 4, and memory 504 includes or corresponds to the memory 416 of FIG. 4. Memory 504 may also be configured to store wireless signal information 506, address information 508, measurement information 542, address mapping information 544, ESL settings information 546, or a combination thereof, as further described herein.

In some implementations, the position information includes location information. The location information includes or corresponds to data associated with or corresponding to a location of an ESL device of the wireless communications system 500. For example, the location information may include data used for determining a location (e.g., measurement data), data indicating a location, data indicating formulas or methods for calculating a location, or a combination thereof. The location information may include or correspond to an initial or original position or location of ESL devices or ESL infrastructure of the wireless communications system 500.

The wireless signal information 506 includes or corresponds to data associated with or corresponding to wireless signals of the wireless communications system 500. For example, the wireless signal information 506 may include data associated with Bluetooth or Wi-Fi transmissions and may enable the generation of measurement information and/or position information.

The address information 508 includes or corresponds to data associated with or corresponding to address information for a particular device. For example, the address information 508 may include one or more different types of address data. To illustrate, the address information may include static address information, public address information, encrypted address information, ESL system address information. As illustrative examples, the address information 508 include MAC address information, public ESL address information, and encrypted ESL address information. The encrypted address information may be dynamic and change over time, such as each ESL duty cycle. In some implementations, the address information 508 (e.g., ESL dynamic and secure address) is included in a beacon transmission from an ESL device (e.g., ESL device 501 and/or ESL device(s) 591) and part of the wireless signal information 506.

The address generation information 509 includes or corresponds to data associated with or corresponding to dynamic and encrypted address generation. For example, the address generation information 509 may include generate function data and/or encryption data for generating a dynamic and encrypted ESL address based on one or more inputs. The inputs may include public address information, address seed information (e.g., a public or dynamic address from another ESL device or a unique string), timestamp information, time slot information, or a combination thereof.

The measurement information 542 includes or corresponds to data associated with or corresponding to measurements of wireless signals of the wireless communications system 500. For example, the measurement information 542 may include measurement data or measurement values associated with transmissions (e.g., Bluetooth or Wi-Fi transmissions) of the wireless communications system 500 and may enable the generation of position/location information. The measurement information 542 may include signal strength or quality measurements, such as RSRP, RSRQ, RSSI, etc. Additionally, or alternatively, the measurement information 542 may include directionality information, such as angle or arrival (AoA) or beam information.

The device position information 543 includes or corresponds to data associated with or corresponding to a position of a non-ESL device, such as wireless device 503. For example, the device position information 543 may include data which indicates or identifies a position of a non-ESL device. To illustrate, the device position information 543 may include positioning information which indicates a position of the device, i.e., position information, or positioning information which may be used (such as with the address mapping information 544) to derive the position of the device, such as measurement information 542. The device position information 543 may enable the generation of notifications (e.g., notification information, indications and/or instructions).

The address mapping information 544 includes or corresponds to data associated with or corresponding to association information between ESL dynamic addresses and ESL positions. For example, the address mapping information 544 may include data indicating encrypted, dynamic ESL addresses of ESL devices, ESL position information of ESL devices, and association information. To illustrate, the address mapping information 544 may include a table of dynamic and encrypted addresses and associated positions of ESL devices with reference to the ESL system. The address mapping information enables an ESL device or a non-ESL device to determine a position of an ESL device using dynamic addresses included in beacons from the ESL device. The determined position of the ESL device (e.g., device position information 543), may then be used to determine a position of the wireless device 503.

The notification information 545 includes or corresponds to data associated with or corresponding to notifications for devices or assets of or associated with the wireless communications system 500. For example, the notification information 545 may include notifications for assets of the wireless communications system 500. To illustrate, the notification may indicate a position and/or status of an IoT tag coupled to an asset. As illustrative examples, the notification may indicate asset moved, asset misplaced, asset stolen, asset not responding, etc.

An asset moved notification may correspond to a notification based on time and position information. For example, one or more threshold periods of time or durations may be used to determine whether an asset moved. The duration may correspond to a beacon interval or multiple beacon intervals. To illustrate, if a position of the asset has changed after a first duration of multiple beacon intervals and remains unchanged thereafter for a second duration of multiple beacon intervals, it is assigned a status of asset moved and notification may be generated and/or transmitted to another device. The first duration and the second duration may be the same of different durations. In other implementations, a threshold amount of times with a same or similar position may be used as an alternative to a duration or in combination with the duration to determine any of the notifications.

An asset misplaced notification may correspond to a notification based on time and position information, and optionally another notification, such as a prior asset moved notification. For example, if an asset is determined to be in another area or section outside of its section or original position for another duration, such as third duration, the asset may be indicated as misplaced. To illustrate, if a food asset is outside of a food section, within a clothes section, and not within a checkout section or passed through a checkout section, an asset misplaced notification may be generated and/or transmitted. The third duration may be the same as the first or second durations or different from one or more of the first or second durations. In a particular implementation, the third duration is much longer than the other durations, to enable a shopper to complete their trip and not provide false positives and/or may be based on the item. For example, clothes may have longer third duration than refrigerator or frozen foods.

An asset stolen notification may correspond to a notification based on time and position information, and optionally another notification, such as a prior asset moved notification. For example, if an asset has determined to have been moved or misplaced and has not been checked out after a fourth duration, an asset stolen notification may be generated. The fourth duration may be the same as the first, second, or third durations or different from one or more of the first, second, or third durations. In some implementations, the asset stolen notification may be further generated based on a purchase or check-out status, whether the object is still in a coverage range, whether the object has passed through a particular area (e.g., checkout or entrance/exit), or a combination thereof. To illustrate, only a subset of assets, which have not been checked our and/or passed through an exit, of all of the assets that have been moved or misplaced and not moved for a fourth duration will be indicated as stolen.

An asset not responding notification may correspond to a notification based on time and position information, and optionally another notification, such as a prior asset moved notification. For example, if an asset has determined to have been moved or misplaced and then is determined have a position within coverage and has not moved for a fifth duration, an asset not responding notification may be generated. To illustrate, if an asset has been moved and then determined to be stationary for a period of time before losing contact and without being checked out or moving out of range or near an entrance/exit, an asset not responding notification may be generated and/or transmitted. As another example, the asset not responding may be determined based on position and independent of time. For example, if the asset has a same position for X amount of time, and then is no longer detectable, an asset not responding notification may be generated and/or transmitted.

As another example, the notification information 545 may include notifications for devices of the wireless communications system 500. To illustrate, the notification information 545 may include notifications for the ESL device 501, the wireless device 503, or both. In some such implementations, the notifications for devices of the wireless communications system 500 may include notifications for or to be outputted by an ESL, and which provide a notification to a UE associated with the wireless communications system 500.

Additionally, or alternatively, the notification information includes notification conditions or thresholds, such as notification condition information or notification thresholds information, for determining a notification or when to transmit a notification. In some implementations, the notification information includes notification history information and/or notification filtering information. The notification history information may include past notifications for devices or assets of the ESL system and the notification filtering information may indicate when to not determine notifications and/or when to not send notifications, such as when restocking or performing another ESL system task.

The ESL settings information 546 includes or corresponds to data associated with enhanced ESL position determination operations and/or enhanced ESL position based notification operations. The ESL settings information 546 may include one or more types of enhanced ESL position determination operation modes and/or enhanced ESL position based notification operation modes and/or thresholds or conditions for switching between such enhanced modes and/or configurations thereof. For example, the ESL settings information 546 may have data indicating different thresholds and/or conditions for different enhanced ESL position determination modes and/or enhanced ESL position based notification modes, or a combination thereof.

Additionally, or alternatively, the ESL settings information 546 includes asset information, ESL device information, gondola information, store information, ESL transmission timing information (e.g., beacon timing information), UL and/or DL position determination modes, associated UE information, or a combination thereof.

Transmitter 510 is configured to transmit data to one or more other devices, and receiver 512 is configured to receive data from one or more other devices. For example, transmitter 510 may transmit data, and receiver 512 may receive data, via a network, such as a wired network, a wireless network, or a combination thereof. For example, wireless device 503 may be configured to transmit and/or receive data via a direct device-to-device connection, a local area network (LAN), a wide area network (WAN), a modem-to-modem connection, the Internet, intranet, extranet, cable transmission system, cellular communication network, any combination of the above, or any other communications network now known or later developed within which permits two or more electronic devices to communicate. In some implementations, transmitter 510 and receiver 512 may be replaced with a transceiver. Additionally, or alternatively, transmitter 510 or receiver 512 may include or correspond to one or more components of ESL device 108A described with reference to FIG. 4.

Encoder 513 and decoder 514 may be configured to encode and decode data for transmission. ESL manager 515 may be configured to perform secure ESL position determination operations and enhanced ESL position based notifications operations. For example, the ESL manager 515 may be configured to manage one or more ESL related services, such as to generate ESL position based requests and process ESL notifications based on ESL based positions. The ESL manager 515 may be configured to generate ESL position based requests or request information based on measurement information, position information, time information, or a combination thereof.

ESL positioning manager 516 may be configured to perform ESL measurement and position determination operations. For example, the ESL positioning manager 516 may be configured to measure ESL transmissions (e.g., beacons) and determine measurement information based on ESL information and transmissions. As another example, the ESL positioning manager 516 may be configured to determine one or more positions of itself or other devices based on measurements of beacons and/or reference signal(s), the measurement information. Additionally, the ESL positioning manager 516 may be configured to determine position or location information of other ESL devices from ESL transmissions, such as based on dynamic, secure ESL address included in beacons and ESL positions indicated by address mapping information. The position information may be used to determine notification information.

In some implementations, the ESL positioning manager 516 may include or correspond to an ESL measurement manager may be configured to perform ESL position measurement and management operations. For example, the ESL measurement manager may be configured to measure received reference signals or beacons (e.g., beacons and/or beacon responses) to determine wireless information, measurement information, or both. The measurement information may be used to determine position information.

Although one wireless device (i.e., wireless device 503) is shown in the example of FIG. 5, in other implementations the network may include additional wireless devices which interact with the ESL infrastructure (e.g., ESL device 501). The other wireless device or devices may include one or more elements similar to wireless device 503. In some implementations, the wireless device 503 and the other wireless device or devices are different types of UEs. For example, either UE may be a higher quality or have different operating constraints. To illustrate, one of the UEs may have a larger form factor or be a current generation device, and thus have more advanced capabilities and/or reduced battery constraints, higher processing constraints, etc. As another example, one UE may be associated with a person and the other UE may be associated with a robot or autonomous device.

ESL device 501 includes processor 530, memory 532, transmitter 534, receiver 536, encoder 537, decoder 538, ESL manager 539, ESL positioning manager 540, and antennas 535a-t. Processor 530 may be configured to execute instructions stores at memory 532 to perform the operations described herein. In some implementations, processor 530 includes or corresponds to low-power microcontroller unit 410 and/or microprocessor 414, and memory 532 includes or corresponds to memory 416 of FIG. 4. Memory 532 may be configured to store ESL position information 507, address generation information 509, device position information 543, notification information 545, ESL settings information 546, or a combination thereof, and optionally other information such as described with reference to the wireless device 503 and as further described herein.

Transmitter 534 is configured to transmit data to one or more other devices, and receiver 536 is configured to receive data from one or more other devices. For example, transmitter 534 may transmit data, and receiver 536 may receive data, via a network, such as a wired network, a wireless network, or a combination thereof. For example, UEs and/or ESL device 501 may be configured to transmit and/or receive data via a direct device-to-device connection, a local area network (LAN), a wide area network (WAN), a modem-to-modem connection, the Internet, intranet, extranet, cable transmission system, cellular communication network, any combination of the above, or any other communications network now known or later developed within which permits two or more electronic devices to communicate. In some implementations, transmitter 534 and receiver 536 may be replaced with a transceiver. Additionally, or alternatively, transmitter 534 or receiver 536 may include or correspond to one or more components of ESL device 108A described with reference to FIG. 4.

Encoder 537, and decoder 538 may include the same functionality as described with reference to encoder 513 and decoder 514, respectively. ESL manager 539 may be configured to perform enhanced ESL position based operations, and may include similar functionality as to ESL manager 515. For example, the ESL manager 539 may be configured to determine configure and/or coordinate ESL system operations. The ESL manager 539 may be configured to obtain initial ESL device position information indicating device positions of ESL devices, to generate and distributed ESL configuration or setup information, to generate one or more ESL dynamic addresses (address information), to transmit beacon start transmissions and/or beacon transmission, to generate address mapping information for the ESL system which associates the dynamic ESL addresses and their position, or a combination thereof. As another example, the ESL manager 539 may be configured to determine ESL based positions for ESL devices or ESL assets and non-ESL devices and/or determine ESL notifications based on ESL based positions.

In some implementations, the ESL manager 539 may be configured to generate notifications or notification information based on measurement information, position information, request information, time information, or a combination thereof. The ESL manager 539 may include an ESL notification manager configured to perform ESL notification determination and management operations. For example, the ESL notification manager may be configured to generate and/or transmit enhanced ESL notifications, such as ESL notifications based on ESL based or determined positions. The ESL notification manager may be configured to determine notifications for assets, determine when and how to send the determined notifications, determine whether to send the determined notifications, or a combination thereof. Additionally, the ESL notification manager may be configured to generation instructions for causing other ESL devices and/or UEs to output notifications, such as visual or auditory outputs, to provide a notification, such as directions, to a user or a UE. In some implementations, the ESL notification manager may include a notification filter configured to filter the generation and/or transmission of notifications.

ESL positioning manager 540 may include similar functionality as described with reference to the ESL positioning manager 516. For example, the ESL positioning manager 540 may be configured to perform ESL position determination operations. To illustrate, the ESL positioning manager 516 may be configured to determine a position of a device (e.g., non-ESL device) based on ESL beacon transmission measurements (measurement information) from the device. The ESL positioning manager 516 may utilize the address mapping information to determine the position based on the measurement information and corresponding dynamic address information corresponding to the measurement information.

In some implementations, the ESL device 501 may include similar functionality as described with reference to the ESL manager 515, the ESL positioning manager 516, or both, of the wireless device 503. Additionally, or alternatively, the wireless device 503 may include similar functionality as described with reference to the ESL manager 539, the ESL positioning manager 540, or both, of the ESL device 501.

During operation of wireless communications system 500, the network (e.g., ESL device 501) may determine that wireless device 503 has ESL position determination and/or ESL position based notification capability. For example, wireless device 503 may transmit a message 548 that includes an ESL position determination and/or ESL position based notification indicator 590 (e.g., an enhanced and/or secure ESL position operations indicator). Indicator 590 may indicate ESL position determination and/or ESL position based notification capability for one or more communication modes, such as uplink, downlink, sidelink, etc. In some implementations, an ESL network entity (e.g., the ESL device 501) sends control information to indicate to the wireless device 503 that secure ESL position determination and secure ESL position based notification operation and/or a particular type of secure ESL position determination and secure ESL position based notification operation is to be used. For example, in some implementations, configuration transmission 550 is transmitted to the wireless device 503. The configuration transmission 550 may include or indicate to use secure ESL position determination operations or secure ESL position based notification operations or to adjust or implement a setting of a particular type of secure ESL position determination operation or secure ESL position based notification operation. For example, the configuration transmission 550 may include ESL position information 507, address information 508, address generation information 509, address mapping information 544, ESL settings information 546, or any combination thereof.

During operation, devices of wireless communications system 500 perform secure ESL position determination and secure ESL position based notification operations. For example, the ESL network and wireless devices may exchange transmissions via uplink, downlink, and/or sidelink communications over the communication links using encrypted, dynamic addresses and engage in secure ESL position determination and ESL position based notification, as illustrated in the example of FIG. 5. Secure ESL position determination operations utilizing encrypted, dynamic addresses enables improved network security and integrity for an ESL system offering ESL position determination operations and ESL notification based on the position, referred to as ESL position based notifications. The enhanced ESL position based notification operations enable ESL devices and/or wireless devices to have increased operational capabilities and the ESL network to have increased automation due to asset monitoring and device guidance and assistance, which improves the functionality and efficiency of ESL systems and devices.

In the example of FIG. 5, the ESL device 501 generates the address mapping information 544 for transmission in a mapping information transmission 552. For example, the ESL device 501 may generate address to position mapping information to enable devices to determine a position of an ESL device based on an encrypted, dynamic address. To illustrate, the ESL device 501 may generate or receive encrypted addresses (address information 508) for one or more of the ESL devices of the ESL system and associate the encrypted, dynamic address with the position of the ESL device. The ESL device 501 may determine a dynamic address for a particular ESL device, and associate that dynamic address with an initial or defined position for the ESL device. This information can then be used by other ESL or external devices to determine their relative position.

As illustrated in the example of FIG. 5, the ESL device 501 transmits the mapping information transmission 552, including the address mapping information 544, via wireless transmission to one or more ESL device, one or more non-ESL devices, or a combination thereof. Examples of address mapping information 544 generation and transmission are described further with reference to FIGS. 6-10, and may include an ESL server, ESL AP, or ESL controller receiving ESL based position information from and determined by a UE. In other implementations, the ESL device 501 generates the mapping information 544 for internal or ESL device use only, and the ESL device 501 uses the mapping information for received measurement information, which is associated with a corresponding encrypted, dynamic address from which the measurement was taken.

ESL devices of the network, such as the ESL device 501, periodically transmit beacons 554, such as described with reference to FIG. 3, and further with reference to FIGS. 6-9. The beacons may be used by ESL and non-ESL devices to determine a relative position from the ESL devices or a position within an ESL system.

The wireless device 503 receives the beacons 554 and measures the beacons 554. For example, the wireless device 503 monitors and receives beacon transmissions from multiple ESL devices, including the ESL device 501, measures the beacon transmissions, and determines a RSSI for each of the beacon transmissions.

In some implementations, the wireless device 503 transmits the measurement information to the ESL device 501. For example, the wireless device 503 generates positioning information based on the measurement information or to include the measurement information. In some such implementations, the ESL device 501 determines position information based on the received positioning information (e.g., measurement information thereof or indicated thereby). For example, the wireless device 503 generates position information based on the positioning information.

In other implementations, the wireless device 503 determines position information based on the measurement information and transmits the position information to the ESL device 501. For example, the wireless device 503 generates positioning information based on the position information or to include the position information. Generation of position information based on measurement information is described further with reference to FIGS. 6-8.

After generation or receipt of the position information by the ESL device 501, the ESL device 501 may use the position information of the wireless device 503 for ESL operations and/or to provide a service for the wireless device 503. For example, the ESL device 501 may provide the position information or a positioning indication to the wireless device 503.

As another example, the ESL device 501 may provide a notification to the wireless device 503, such as in response to a request from the wireless device 503. The ESL device 501 generates a notification 558 based on the position information. As described above, the notification 558 may include or correspond to a notification for a particular asset in some implementations. For example, the notification 558 may include a notification for the ESL system (e.g., a UE or ERP system associated with the ESL system) and regarding an asset or ESL device of the system. To illustrate, the notification may indicate position relative to an asset, directions to the asset, a status of the asset, etc.

In other implementations, the notification 558 may include or correspond to a notification for a particular ESL device or UE. For example, the notification 558 may include a notification for an ESL and which is configured to cause a display, LED, or speaker of the ESL to output a visual output, an audio output, or both. The visual and/or audio output may be directed at or intended for a UE device (or user thereof) to provide directions to an asset or to assist with an ESL system related task (e.g., restocking, organizing, shopping, etc.) As another example of a notification for a UE, the notification 558 may include a notification for a UE device which is configured to cause a display, LED, or speaker of the UE to output a visual output, an audio output, or both to indicate directions or guidance to an ESL device, an asset, or both. In a particular implementations, the ESL device 501 may generate both types of notifications.

The ESL device 501 may then transmit notification 558 to one or more devices of the ESL network. For example, the ESL device 501 may send one or more transmissions including or indicating the notification 558, or based on the notification 558. In some implementations, the ESL device 501 transmits the notification 558 to the wireless device 503, and optionally other devices. Generation of notifications, transmission of notifications, and illustrative examples of notifications are described further with reference to FIGS. 6-10.

Accordingly, the network (e.g., the ESL device 501 and the wireless device 503) may be able to perform secure ESL position determination, and optionally ESL position based notification operations. Accordingly, the ESL network performance and ESL network and user experience may be increased due to enhanced ESL system capabilities based on ESL based positions and notifications.

Referring to FIG. 6, FIG. 6 is a timing diagram 600 illustrating an ESL system that supports secure positioning determination and secure position based notifications according to one or more aspects. The example of FIG. 6 corresponds to an example of secure downlink position determination by a device interacting with the ESL system where the position is determined based on signals or beacons from ESL radios/controllers, which may be triggered by an ESL device (e.g., ESL server or ESL AP). The example FIG. 6 may enable secure determination of ESL based positions (e.g., a position within or with reference to an ESL system or ESL infrastructure) by external devices based on signals and information from one or more ESL infrastructure devices.

In the example of FIG. 6, the ESL system includes an ESL server 602, an ESL AP 604, an ESL controller 606, and a device 608 (e.g., UE). The ESL controller 606 may include or correspond to an ESL with a wireless radio or a wireless device/radio associated with a plurality of ESLs.

At 610, the ESL system may be configured with initial position information and/or configurations for network operation and secure positioning. For example, an operator may setup or preconfigure the system with initial positions for one or more devices and/or assets of the ESL systems. To illustrate, one or more of ESL APs, ESL controllers, ESLs, or assets (which may be tagged with an IoT tag) may be configured with an initial position. As another example, the ESL system may enter, such as upon initial setup, reconfiguration, or periodically (e.g., nightly weekly, monthly, quarterly, etc.), a measurement mode to determine initial or updated positions.

In the example of FIG. 6, the ESL server 602 transmits configuration information (e.g., the configuration transmission 550 or the ESL settings information 546 of FIG. 5) to the ESL AP 604 and the ESL controller 606. For example, the ESL server 602 may transmits the configuration information directly to each device, such as by broadcast transmission or direct transmission, or the ESL server 602 may transmit the configuration information to ESL AP 604, which then transmits or relays then configuration information to one or more ESL devices, such as the ESL controller 606. In an illustrative, non-limiting example, the ESL server 602 may transmit the configuration to ESL AP 604 via a wired connection, and the ESL AP 604 may unicast or broadcast the configuration information to the ESL devices and non-ESL devices.

As described above, the configuration information may include information configured to enable dynamic and secure address generation. For example, the configuration information may include address generation information, such as an encryption method or scheme used to generate an address.

Additionally, or alternatively, initial position information may be transmitted. For example, the operator may input a position into the ESL controller 606, and the ESL controller 606 may relay that position to the ESL server 602 via the ESL AP 604. As another example, the operator may configure the ESL server with the position of the ESL controller 606, which is then relayed to the ESL controller 606 via the ESL AP 604. As yet another example, the ESL controller 606 determines its position based on a beacon of the ESL AP 604, and transmits its determined position to the ESL server 602.

At 615, the ESL server 602 may transmit address information to the ESL AP 604 for address generation for secure position determination by devices outside of the ESL system. For example, the ESL server 602 may unicast or broadcast a transmission to one or more ESL APs, including the ESL AP 604, which indicates or includes the address information.

At 620, the ESL AP 604 may determine a dynamic address for secure positioning. For example, the ESL AP 604 may generate a dynamic address of or for the ESL AP 604 based on the address information, and optionally the configuration information, from the ESL server 602. The address information may include or correspond to a public or common or static address (e.g., first address) of or for the ESL AP 604 or received sending device address information (e.g., address of ESL server 602), and the dynamic address may include or correspond to a second or secure address of or for the ESL AP 604. Alternatively, the address information may include or correspond to address generation information, such as address seed information, which enables the ESL AP 604 to generate the dynamic address based on or using the configuration information. To illustrate, the configuration information may indicate or include an encryption method or random number generator information, which is used by the ESL AP 604 to generate the dynamic address based on the address information.

In some implementations, the dynamic address of or for the ESL AP 604 is generated based on received information and based on stored device information. For example, the ESL AP 604 may determine a generator function from the configuration information and utilize an address of the ESL server 602 indicated in the message or received address seed information included in the message, along with static device address information (e.g., MAC address) to generate the dynamic address of or for the ESL AP 604. Additionally, or alternatively, the ESL AP 604 may utilize timestamp information or time-slot information to generate the dynamic address. In other implementations, the ESL server 602 to ESL AP 604 communications may be secure, such as encrypted or wired, and the ESL server 602 may indicate the dynamic address of the ESL AP 604 directly.

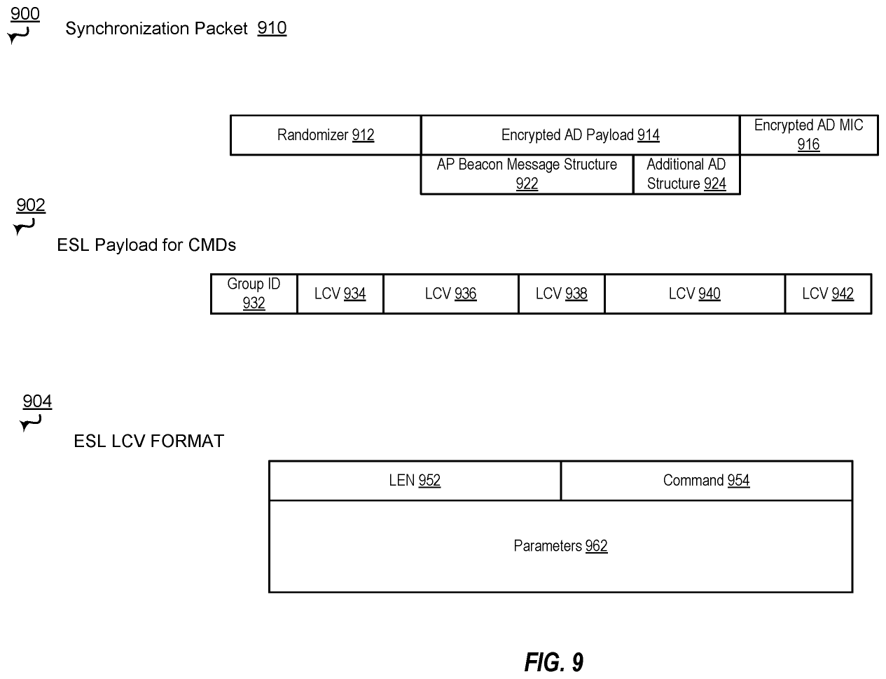

At 625, the ESL AP 604 may initiate beacon transmissions by ESL devices. For example, the ESL AP 604 may transmit a beacon start transmission, such as the broadcast transmission at 302 of FIG. 3. To illustrate, the ESL AP 604 may broadcast a transmission which is configured to cause ESL controllers, including ESL controller 606, to transmit beacon transmissions, cause devices (e.g., device 608) to measure the beacon transmissions, or both. The beacon start transmission may include or correspond to a configuration transmission or a Bluetooth transmission. The beacon start transmission (or beacon start message) may correspond to a synchronization packet, such as a synchronization packet as described with reference to FIG. 9.

In some implementations, the beacon start transmissions sent by the ESL APs, such as ESL AP 604, include or indicate dynamic address information for the address of the ESL AP. The dynamic address may be a one-time or short time span public address of the ESL AP which is indicated as the sending address of the device which transmitted the beacon start transmission. As described above, the address information of the ESL AP 604 may be generated dynamically every cycle (e.g., beacon start timer or address generation timer) and/or based on a transmission which from the ESL server 602. The dynamic address is also an encrypted address as the address cannot be reverse engineered by external devices without information from the ESL network, such as address generator information (e.g., a specific encryption technique or address generation function). Additionally, or alternatively, the address may not be reversed engineered by external devices because it may be generated based on a static secure piece of information associated with the ESL AP, such as a static internal address or seed value.

At 630, the ESL controllers may determine a dynamic address for secure positioning. For example, the ESL controller 606 may generate a dynamic address of or for the ESL controller 606 based on the beacon start transmission, and optionally the configuration information, from the ESL server 602. The beacon start transmission indicates or includes the address of the ESL AP 604, such as dynamic address information, and the address of the ESL AP 604 may be used as address generation information by the ESL controllers, such as ESL controller 606. The dynamic address information may include or correspond to a dynamic and secure address (e.g., second address) of or for the ESL AP 604. The ESL controller 606 may generate its own dynamic secure address based on the address (e.g., dynamic address) of the ESL AP 604, or based on other address generation information indicated by or included in the beacon start transmission, such as unique bit sequence or value.

As compared to the ESL AP 604, the ESL controller 606 may generate its dynamic address in a same or similar manner, or in a different manner. For example, the ESL controller 606 may also utilize stored device information to generate its dynamic address.

To illustrate, the ESL controller 606 may generate its dynamic address based on address generation information of the beacon start transmission and based on the stored device information, and optional based on the configuration information. As an illustrative, non-limiting example, the address generation information is the dynamic address of the ESL AP 604 and the stored device information is a static or configured address for the ESL controller (e.g., a MAC address or an ESL system specific static address) and based on a framework or scheme from the configuration information. For example, the configuration information may indicate the static address and/or may indicate or provide AES encryption information or random or pseudo random number generation information for generating the dynamic address.

Alternatively, the address information may include or correspond to address generation information, such as address seed information, which enables the ESL AP 604 to generate the dynamic address based on or using the configuration information. To illustrate, the configuration information may indicate or include an encryption method or random number generator information, which is used by the ESL AP 604 to generate the dynamic address based on the address information.

At 635, the ESL controllers/radios transmit beacons responsive to the beacon start transmission (e.g., beacon frame or synchronization transmission). For example, the ESL controller 606 and one or more other controllers each transmit a beacon (beacon transmission) responsive to the beacon start transmission from the ESL AP 604. To illustrate, the ESL controller 606 broadcasts a first beacon after a first delay from the beacon start transmission, and a second ESL controller broadcasts a second beacon after a second delay from the beacon start transmission, etc., in a TDMA fashion, similar to the operations of FIG. 3. The beacon transmissions may include or correspond to Bluetooth transmissions and may correspond to responses to synchronization packets, such as a synchronization packet as described with reference to FIG. 9.

In some implementations, beacons sent by ESL controller include or indicate dynamic address information for the address of the ESL controller. The dynamic address may be a one-time or short time span public address of the ESL controller which is indicated as the sending address of the device which transmitted the beacon. As described above, the address information of the ESL controller 606 may be generated dynamically based on received beacon start transmission from the ESL AP 604. The dynamic address is also an encrypted address as the address cannot be reverse engineered by external devices without information from the ESL network, such as address generator information (e.g., a specific encryption technique or address generation function). Additionally, or alternatively, the address may not be reversed engineered by external devices because it may be generated based on a static secure piece of information associated with the ESL controller, such as a static internal address or seed value.

At 640, the ESL server 602 may transmit mapping information to the device 608 for secure position determination. For example, the ESL server 602 may unicast or broadcast a transmission to one or more ESL APs, including the ESL AP 604, which indicates or includes the mapping information, and the ESL AP 604 then relays the mapping information to the device 608, such as by WiFi or Bluetooth transmission. As another example, the ESL server 602 may transmit the mapping information to the device 608 via another wireless network, such as a cellular network, or via the internet.

As described with reference to FIG. 5, the ESL server 602 may generate the mapping information based on the configuration information and the address information. For example, the ESL server 602 may generate mapping information to indicate the position of the ESL devices, such as the ESL controller 606 and other ESL controllers and a corresponding dynamic address which was generated based on the address information sent to ESL AP 604 at 615. In some implementations, the mapping information is dynamic as well and is periodically updated and pushed to the device 608, such as every duty cycle of the ESL controller 606. For example, the ESL server 602 may generate first mapping information for the address information sent at 615 and may generate second mapping information for second address information sent to the ESL AP 604 which is used to generate another dynamic address and beacon start transmission not shown in FIG. 6.

At 645, the device 608 receives two or more beacons and measures the two or more beacons. For example, the device 608 measures a first RSSI from the first beacon from the ESL controller 606 and a second RSSI of the second beacon from another ESL controller. The device 608 may generate measurement information based on performing one or more measurement operations on the received beacons from ESL controllers. Additionally, or alternatively, the measurement information may include RSRP, AoA, or both.

As described above, the beacons include a dynamic and encrypted address as the sending address of the ESL controller which sent the beacon. This enables outside devices, such as device 608, to properly identify which ESL controller sent the beacon for this cycle or beacon transmission, but not be able to identify ESL controllers from cycle to cycle without the mapping information which identifies, associates or correlates ESL position of the ESL controllers to the current dynamic address of the beacon, to enable secure ESL position determination for this cycle. After new dynamic addresses are generated, the device 608 will need new mapping information to determine the position of the device 608.

At 650, the device 608 determines a position for the device 608 based on the beacon measurement information. For example, the device 608 determines a position, positioning information, of the device 608 based on the first measurement information (e.g., a first RSSI) from the first beacon from the ESL controller 606 and the second measurement information (e.g., a second RSSI) from the second beacon from another ESL controller. In some implementations, the device 608 determines the position of the device 608 based on the additional (e.g., third) measurement information from one or more other beacons and based on historical measurement information, historical position information, or inertial information. For example, the device 608 may determine the position by adjusting an initial measured position based on inertial movement since a prior positioning determination, based on prior positions, and/or prior beacon measurements.

At 655, the device 608 transmits positioning information for the device 608 to the ESL system. For example, the device 608 transmits the positioning information indicating the determined position of the device 608 to the ESL server 602 via the ESL AP 604. In some implementations, the device 608 transmits a request, such as request information, indicating a position based request to the ESL system. For example, the device 608 may transmit a request to find a specific object or product (e.g., ESL associated with the object or product). The request may be sent with or independent of the positioning information. The ESL system may then use the positioning information to provide services to the device (e.g., a user thereof), such as guidance, and/or may use the positioning information to improve ESL operations.

At 660, the ESL system determines a notification based on the positioning information. For example, the ESL server 602 determines a request for directions from the device 608 for a particular object, and the ESL server determines directions from the position of the device 608 indicated by the positioning information to a position of the object or product stored in the ESL system.

At 665, the ESL system transmits the notification based on the positioning information, and optionally the request information. For example, the ESL server 602 transmits a notification indicating the directions from the position of the device 608 to the position of the object or product stored in the ESL system.

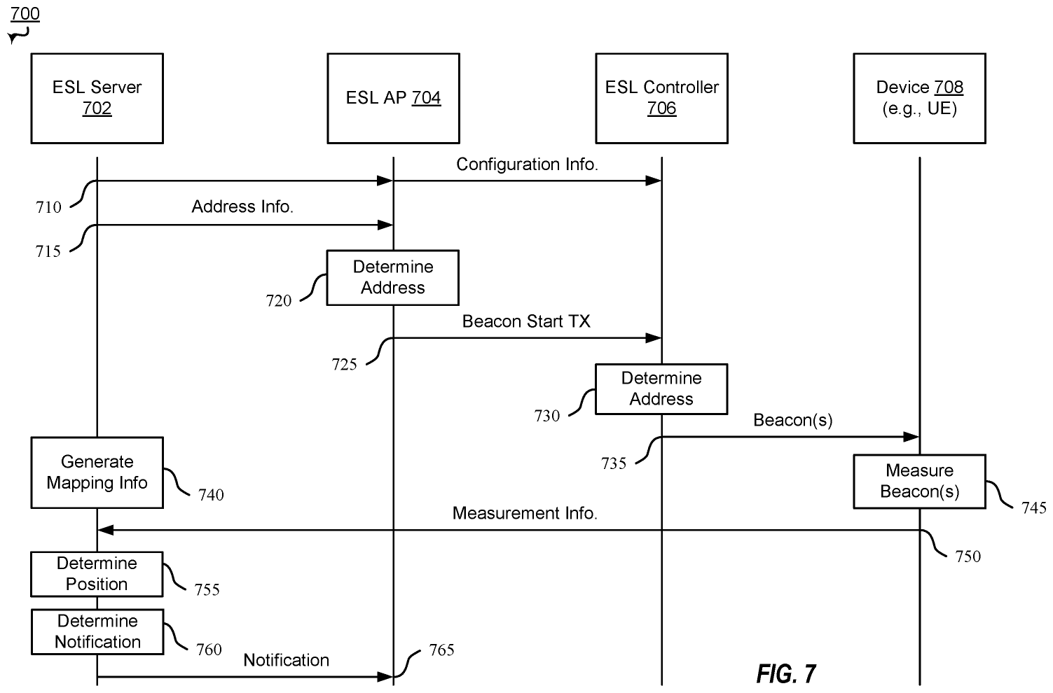

Referring to FIG. 7, FIG. 7 is a timing diagram 700 illustrating an ESL system that supports secure positioning determination and secure position based notifications according to one or more aspects. The example of FIG. 7 corresponds to an example of secure uplink position determination for a device interacting with the ESL system where the measurements are determined based on signals or beacons from ESL radios/controllers by the device, and then relayed to the ESL system for secure position determination. As compared to FIG. 6, the example of FIG. 7 may not transmit or broadcast address mapping information to outside or non-ESL devices. The example FIG. 7 may enable secure determination of ESL based positions (e.g., a position within or with reference to an ESL system or ESL infrastructure) for external devices based on signals and information from one or more ESL infrastructure devices.

In the example of FIG. 7, the ESL system includes an ESL server 702, an ESL AP 704, an ESL controller 706, and a device 708 (e.g., UE 115). The ESL controller 706 may include or correspond to an ESL with a wireless radio or a wireless device/radio associated with a plurality of ESLs.

At 710, the ESL system may be configured with initial position information and/or configurations for network operation and secure positioning. For example, an operator may setup or preconfigure the system with initial positions for one or more devices and/or assets of the ESL systems. To illustrate, one or more of ESL APs, ESL controllers, ESLs, or assets (which may be tagged with an IoT tag) may be configured with an initial position. As another example, the ESL system may enter, such as upon initial setup, reconfiguration, or periodically (e.g., nightly weekly, monthly, quarterly, etc.), a measurement mode to determine initial or updated positions.

In the example of FIG. 7, the ESL server 702 transmits configuration information (e.g., the configuration transmission 550 or the ESL settings information 546 of FIG. 5) to the ESL AP 704 and the ESL controller 706. For example, the ESL server 702 may transmits the configuration information directly to each device, such as by broadcast transmission or direct transmission, or the ESL server 702 may transmit the configuration information to ESL AP 704, which then transmits or relays then configuration information to one or more ESL devices, such as the ESL controller 706. In an illustrative, non-limiting example, the ESL server 702 may transmit the configuration to ESL AP 704 via a wired connection, and the ESL AP 704 may unicast or broadcast the configuration information to the ESL devices and non-ESL devices.

As described above, the configuration information may include information configured to enable dynamic and secure address generation. For example, the configuration information may include address generation information, such as an encryption method or scheme used to generate an address.

Additionally, or alternatively, initial position information may be transmitted. For example, the operator may input a position into the ESL controller 706, and the ESL controller 706 may relay that position to the ESL server 702 via the ESL AP 704. As another example, the operator may configure the ESL server with the position of the ESL controller 706, which is then relayed to the ESL controller 706 via the ESL AP 704. As yet another example, the ESL controller 706 determines its position based on a beacon of the ESL AP 704, and transmits its determined position to the ESL server 702.

At 715, the ESL server 702 may transmit address information to the ESL AP 704 for address generation for secure position determination by devices outside of the ESL system. For example, the ESL server 702 may unicast or broadcast a transmission to one or more ESL APs, including the ESL AP 704, which indicates or includes the address information.

At 720, the ESL AP 704 may determine a dynamic address for secure positioning. For example, the ESL AP 704 may generate a dynamic address of or for the ESL AP 704 based on the address information, and optionally the configuration information, from the ESL server 702. The address information may include or correspond to a public or common or static address (e.g., first address) of or for the ESL AP 704 or received sending device address information (e.g., address of ESL server 702), and the dynamic address may include or correspond to a second or secure address of or for the ESL AP 704. Alternatively, the address information may include or correspond to address generation information, such as address seed information, which enables the ESL AP 704 to generate the dynamic address based on or using the configuration information. To illustrate, the configuration information may indicate or include an encryption method or random number generator information, which is used by the ESL AP 704 to generate the dynamic address based on the address information.

In some implementations, the dynamic address of or for the ESL AP 704 is generated based on received information and based on stored device information. For example, the ESL AP 704 may determine a generator function from the configuration information and utilize an address of the ESL server 702 indicated in the message or received address seed information included in the message, along with static device address information (e.g., MAC address) to generate the dynamic address of or for the ESL AP 704. Additionally, or alternatively, the ESL AP 704 may utilize timestamp information or time-slot information to generate the dynamic address. In other implementations, the ESL server 702 to ESL AP 704 communications may be secure, such as encrypted or wired, and the ESL server 702 may indicate the dynamic address of the ESL AP 704 directly.

At 725, the ESL AP 704 may initiate beacon transmissions by ESL devices. For example, the ESL AP 704 may transmit a beacon start transmission, such as the broadcast transmission at 302 of FIG. 3. To illustrate, the ESL AP 704 may broadcast a transmission which is configured to cause ESL controllers, including ESL controller 706, to transmit beacon transmissions, cause devices (e.g., device 708) to measure the beacon transmissions, or both. The beacon start transmission may include or correspond to a configuration transmission or a Bluetooth transmission. The beacon start transmission (or beacon start message) may correspond to a synchronization packet, such as a synchronization packet as described with reference to FIG. 9.

In some implementations, the beacon start transmissions sent by the ESL APs, such as ESL AP 704, include or indicate dynamic address information for the address of the ESL AP. The dynamic address may be a one-time or short time span public address of the ESL AP which is indicated as the sending address of the device which transmitted the beacon start transmission. As described above, the address information of the ESL AP 704 may be generated dynamically every cycle (e.g., beacon start timer or address generation timer) and/or based on a transmission which from the ESL server 702. The dynamic address is also an encrypted address as the address cannot be reverse engineered by external devices without information from the ESL network, such as address generator information (e.g., a specific encryption technique or address generation function). Additionally, or alternatively, the address may not be reversed engineered by external devices because it may be generated based on a static secure piece of information associated with the ESL AP, such as a static internal address or seed value.

At 730, the ESL controllers may determine a dynamic address for secure positioning. For example, the ESL controller 706 may generate a dynamic address of or for the ESL controller 706 based on the beacon start transmission, and optionally the configuration information, from the ESL server 702. The beacon start transmission indicates or includes the address of the ESL AP 704, such as dynamic address information, and the address of the ESL AP 704 may be used as address generation information by the ESL controllers, such as ESL controller 706. The dynamic address information may include or correspond to a dynamic and secure address (e.g., second address) of or for the ESL AP 704. The ESL controller 706 may generate its own dynamic secure address based on the address (e.g., dynamic address) of the ESL AP 704, or based on other address generation information indicated by or included in the beacon start transmission, such as unique bit sequence or value.

As compared to the ESL AP 704, the ESL controller 706 may generate its dynamic address in a same or similar manner, or in a different manner. For example, the ESL controller 706 may also utilize stored device information to generate its dynamic address. To illustrate, the ESL controller 706 may generate its dynamic address based on address generation information of the beacon start transmission and based on the stored device information, and optional based on the configuration information. As an illustrative, non-limiting example, the address generation information is the dynamic address of the ESL AP 704 and the stored device information is a static or configured address for the ESL controller (e.g., a MAC address or an ESL system specific static address) and based on a framework or scheme from the configuration information. For example, the configuration information may indicate the static address and/or may indicate or provide AES encryption information or random or pseudo random number generation information for generating the dynamic address.

Alternatively, the address information may include or correspond to address generation information, such as address seed information, which enables the ESL AP 704 to generate the dynamic address based on or using the configuration information. To illustrate, the configuration information may indicate or include an encryption method or random number generator information, which is used by the ESL AP 704 to generate the dynamic address based on the address information.

At 735, the ESL controllers/radios transmit beacons responsive to the beacon start transmission (e.g., beacon frame or synchronization transmission). For example, the ESL controller 706 and one or more other controllers each transmit a beacon (beacon transmission) responsive to the beacon start transmission from the ESL AP 704. To illustrate, the ESL controller 706 broadcasts a first beacon after a first delay from the beacon start transmission, and a second ESL controller broadcasts a second beacon after a second delay from the beacon start transmission, etc., in a TDMA fashion, similar to the operations of FIG. 3. The beacon transmissions may include or correspond to Bluetooth transmissions and may correspond to responses to synchronization packets, such as a synchronization packet as described with reference to FIG. 9.

In some implementations, beacons sent by ESL controller include or indicate dynamic address information for the address of the ESL controller. The dynamic address may be a one-time or short time span public address of the ESL controller which is indicated as the sending address of the device which transmitted the beacon. As described above, the address information of the ESL controller 706 may be generated dynamically based on received beacon start transmission from the ESL AP 704. The dynamic address is also an encrypted address as the address cannot be reverse engineered by external devices without information from the ESL network, such as address generator information (e.g., a specific encryption technique or address generation function). Additionally, or alternatively, the address may not be reversed engineered by external devices because it may be generated based on a static secure piece of information associated with the ESL controller, such as a static internal address or seed value.

At 740, the ESL server 702 may generate mapping information for secure position determination. For example, the ESL server 702 may generate dynamic and encrypted ESL addresses from one or more ESL devices of the ESL system. To illustrate, the ESL server 702 may generate dynamic and encrypted addresses from ESL AP, such as ESL AP 704, ESL controllers, such as ESL controller 706, or both. The ESL server 702 may then update the mapping information periodically, such as for each duty cycle or beacon start transmission. The ESL server 702 may associate the generated dynamic addresses with a corresponding position of the ESL device and the generated dynamic addresses match the addresses generated by the devices themselves. To illustrate, the ESL server 702 includes the same address generator information and stored ESL device information to also generate the dynamic address. The ESL server 702 may use its own ESL or universal device identification or address information to associate the dynamic address for the ESL device with the ESL position for the ESL device.

Although the example of FIG. 7 depicts that the mapping information is generated after the transmission of the beacon transmission, the mapping information may be determined at any time after the address information is transmitted at 715, including after receipt of the measurement information at 750. As compared to the example of FIG. 6 for UL or device based positioning determination where the ESL server 702 provides the mapping information to external or non-ESL devices (e.g., device 608), in the example of FIG. 7 the ESL server 702 does not provide the mapping information to external or non-ESL devices (e.g., device 708) and instead receives measurement information associated with ESL address information and determines the position.

In some implementations, the ESL server 702 may provide the mapping information to other ESL devices, such as an ESL AP. In some such implementations, the other ESL device, such as ESL AP 704, may determine the position information based on received measurement information from non-ESL devices. For example, the ESL server 702 may unicast or broadcast a transmission to one or more ESL APs, including the ESL AP 704, which indicates or includes the mapping information.

As described with reference to FIGS. 5 and 6, the ESL server 702 may generate the mapping information based on the configuration information and the address information. For example, the ESL server 702 may generate mapping information to indicate the position of the ESL devices, such as the ESL controller 706 and other ESL controllers and a corresponding dynamic address which was generated based on the address information sent to ESL AP 704 at 715. In some implementations, the mapping information is dynamic as well and is periodically updated and pushed to the device 708, such as every duty cycle of the ESL controller 706. For example, the ESL server 702 may generate first mapping information for the address information sent at 715 and may generate second mapping information for second address information sent to the ESL AP 704 which is used to generate another dynamic address and beacon start transmission not shown in FIG. 7.

At 745, the device 708 receives two or more beacons and measures the two or more beacons. For example, the device 708 measures a first RSSI from the first beacon from the ESL controller 706 and a second RSSI of the second beacon from another ESL controller. The device 708 may generate measurement information based on performing one or more measurement operations on the received beacons from ESL controllers. Additionally, or alternatively, the measurement information may include RSRP, AoA, or both.

As described above, the beacons include a dynamic and encrypted address as the sending address of the ESL controller which sent the beacon. This enables outside devices, such as device 708, to properly identify which ESL controller sent the beacon for this cycle or beacon transmission, but not be able to identify ESL controllers from cycle to cycle without the mapping information which identifies, associates or correlates ESL position of the ESL controllers to the current dynamic address of the beacon, to enable secure ESL position determination for this cycle. After new dynamic addresses are generated, the device 708 will need new mapping information to determine the position of the device 708.

At 750, the device 708 transmits measurement information for the device 708 to the ESL system. For example, the device 708 transmits the measurement information, which when used with the mapping information can be used to determine position of the device 708, to the ESL server 702 via the ESL AP 704. In some implementations, the device 708 transmits a request, such as request information, indicating a position based request to the ESL system. For example, the device 708 may transmit a request to find a specific object or product (e.g., ESL associated with the object or product). The request may be sent with or independent of the positioning information. The ESL system may then use the positioning information to provide services to the device (e.g., a user thereof), such as guidance, and/or may use the positioning information to improve ESL operations.

At 755, the ESL server 702 determines a position for the device 708 based on the received beacon measurement information from the device 708. For example, the ESL server 702 determines a position, positioning information, of the device 708 based on the first measurement information (e.g., a first RSSI) from the first beacon from the ESL controller 706 and the second measurement information (e.g., a second RSSI) from the second beacon from another ESL controller. In some implementations, the ESL server 702 determines the position of the device 708 based on the additional (e.g., third) measurement information from one or more other beacons and based on historical measurement information, historical position information, or inertial information. For example, the ESL server 702 may determine the position for the device 708 by adjusting an initial measured position based on prior positions, and/or prior beacon measurements.

At 760, the ESL system determines a notification based on the positioning information. For example, the ESL server 702 determines a request for directions from the device 708 for a particular object, and the ESL server determines directions from the position of the device 708 indicated by the positioning information to a position of the object or product stored in the ESL system.

At 765, the ESL system transmits the notification based on the positioning information, and optionally the request information. For example, the ESL server 702 transmits a notification indicating the directions from the position of the device 708 to the position of the object or product stored in the ESL system.

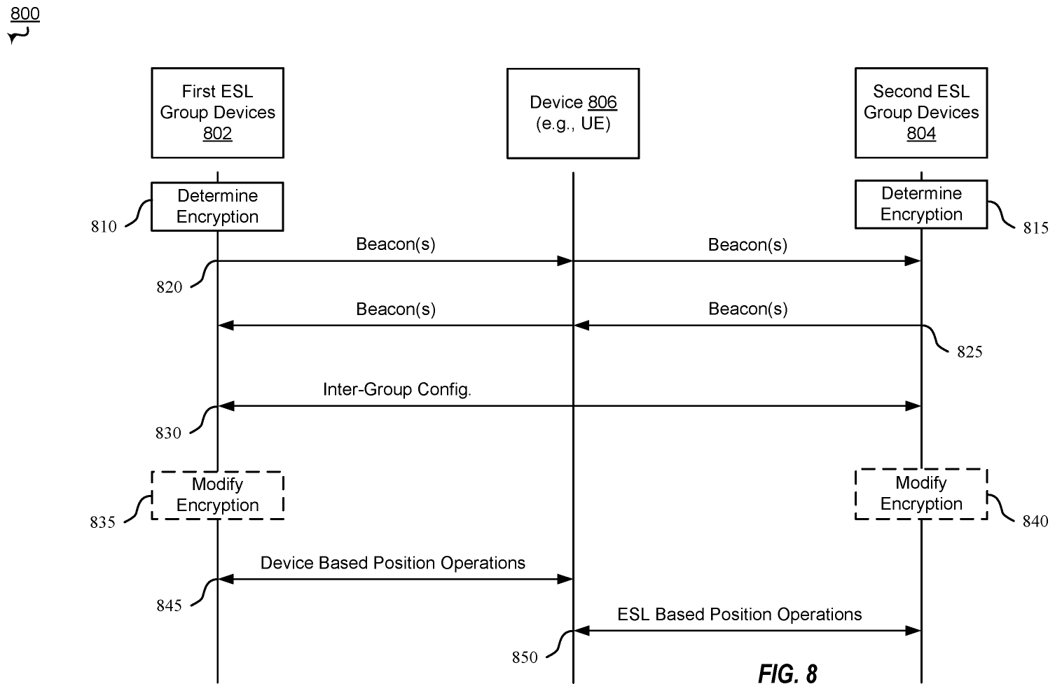

Referring to FIG. 8, FIG. 8 is a timing diagram 800 illustrating an example of secure position based ESL systems that support enhanced interoperability operations according to one or more aspects. The example of FIG. 8 corresponds to an example where to separate, secure ESL systems are operating within range of one another. For example, devices of a first group (Group A) may be in range of receiving transmissions from devices of a second group (Group B). In order to ensure secure communications for each of the groups, devices of the groups (ESL devices of the ESL groups) may advertise or coordinate their address generation or encryption methods to ensure that each group of devices may be able to operate in overlapping spaces, such as without address overlap or address confusion. The example operations in FIG. 8 may enable enhanced interoperation between multiple ESL groups utilizing secure position operations and dynamic addresses, and may enable coordination between the ESL groups, including regarding ESL address generation.

In the example of FIG. 8, the ESL system includes a plurality of ESLs, a first group of ESL devices (first ESL group devices 802) and a second group ESL devices (second ESL group devices 804), and includes one or more external devices, such as a device 806. Each ESL may include or correspond to an ESL controller or an ESL AP of FIGS. 6 and 7. The device 806 may include or correspond to an ESL system UE or device (e.g., employee UE, robot UE, barcode scanner, etc.) or to a non-ESL system UE or device (e.g., a shopper or customer UE).

Prior to operation, and optionally periodically during operation, the ESL systems may determine an encryption method or address generation scheme for generating secure, dynamic addresses for ESL devices which can be used for position determination, as described with reference to FIGS. 5-7. For example, at 810 the first ESL group devices 802 determine a first address encryption method, and at 815 the second ESL group devices 804 determine a second address encryption method. However, in some implementations, the first and second address encryption methods may generate addresses which overlap and/or which otherwise interfere with each other. As an illustrative example, an address generated by a device of the first ESL group devices 802 may overlap with an address range or scheme of the first ESL group devices 804. This overlap may interfere with operations of the first ESL group devices 802 and the second ESL group devices 804.

To resolve and/or prevent such address generation issues, the ESL systems may engage in secure ESL interoperability operations. For example, one of the ESL systems may broadcast an advertising beacon with some encryption information or address generation information to ensure other ESL systems do not utilize similar encryption or address generation methods or with a flag or indicator that secure ESL positioning is enabled.

From 820 to 840, the ESL systems may engage in secure ESL interoperability operations. For example, one of the ESL systems may broadcast an advertising beacon with some encryption information or address generation information to ensure other ESL systems do not utilize similar encryption or address generation methods or with a flag or indicator that secure ESL positioning is enabled.

As illustrated in FIG. 8, a device of the first ESL group devices 802 may broadcast a transmission which includes and secure position indicator or address generation information and that is received by one or more devices of the second ESL group devices 804, at 820, and optionally, a device of the second ESL group devices 804 may broadcast a transmission which includes and secure position indicator or address generation information and that is received by one or more devices of the first ESL group devices 802, at 825.

The devices may then engage in establishing a secure communication link to securely communicate with one another to ensure or guard against address generation overlap. For example, one or more devices of the first ESL group devices 802 and one or more devices of the second ESL group devices 804 may participated in inter-group configuration operations at 830. To illustrate, the devices may each exchange address information (e.g., address range information), address generation information (e.g., encryption schemes, input information, etc.), or a combination thereof to ensure no overlap in the encrypted addresses. As another example, the devices may engage in negotiations to agree upon different randomization strategies via encrypted payloads that cannot be decoded by external entities.

As an illustrative, non-limiting and simplified example, the first ESL group devices 802 may be using generator function that uses the current timestamp (or time slot index) along with device ID, to generate the encrypted address. This first generator function may be included in a broadcast from or in a securely transmitted unicast frame to ensure that the second ESL group devices 804 choose a different generator function (second generator function).

In some implementations, devices within a same ESL ecosystem or from a same vendor may be associated with a pre-configured set of generator functions and key-rotation parameters. In some such implementations, the devices of different ESL systems may negotiate to use different generator functions of the pre-configured set of generator functions and/or different parameters.

At 835, the first ESL group devices 802 may modify an encryption scheme. For example, a device (e.g., ESL server or ESL AP) may determine to modify an address generation scheme for ESL device (e.g., ESL controllers) based on the beacon(s) from the second ESL group devices 804 and/or the inter-group configuration operations (e.g., transmissions).

At 840, the second ESL group devices 804 may also modify an encryption scheme. For example, a device (e.g., ESL server or ESL AP) may determine to modify an address generation scheme for ESL device (e.g., ESL controllers) based on the beacon(s) from the first ESL group devices 802, the inter-group configuration operations (e.g., transmissions), and/or one or more additional beacons from the first ESL group devices 802 after determination or modification of the encryption or address generation scheme of the first ESL group devices 802 at 835.

As an illustrative, non-limiting example, the first ESL group devices 802 use a generator function ‘A’ with a common key ‘K’ and 100 bits of current timestamp followed by 28 ‘0’ bits as input, and the second ESL group devices 804 use a generator function ‘B’ with a common key ‘K’ and 80 bits of current timestamp followed by 48 ‘1’ bits as input. As an illustrative, non-limiting example, the first ESL group devices 802 use the current 128-bit timestamp as input to a generator function ‘A’ and key ‘K1’, and the second ESL group devices 804 use the current 128-bit timestamp as input to a generator function ‘A’ and key ‘K2’.

At 845, the first ESL group devices 802 may perform ESL operations and one or more external devices, such as device 806, may perform secure ESL position determination operations as described herein. For example, the device 806 may interact with the first ESL group devices 802 similar to as described with reference to FIG. 6 and perform device based position determination operations.

At 850, the second ESL group devices 804 may perform ESL operations and one or more external devices, such as device 806, may perform secure ESL position determination operations as described herein. For example, the device 806 may interact with the second ESL group devices 804 similar to as described with reference to FIG. 7 and perform ESL network based position determination operations. Although the device 806 is illustrated as participating in both ESL networks in the example of FIG. 8, in other implementations, a device may participate in one ESL network, and other nearby devices may be participating in another ESL network.

Referring to FIG. 9, Diagram 900 illustrates a diagram of an example of a synchronization packet 910 according to one or more aspects of the disclosure. As depicted by diagram 900, the example of the synchronization packet 910 includes multiple fields 912-916. In the example of FIG. 9, the synchronization packet 910 includes a randomizer field 912, an AD payload field 914, and an encrypted AD MIC field 916.

The randomizer field 912 includes randomized packet address information indicating a destination or intended recipient of the synchronization packet 910. The packet address information may be randomized to prevent outside devices from using or decoding the packets.

The AD payload field 914 includes payload information for the synchronization packet 910. In the example of FIG. 9, the AD payload field 914 includes include an AP beacon message 922 and additional AD structure information 924. The AP beacon message 922 and the additional AD structure information 924 may correspond to dedicated portions or subfields of the AD payload field 914. The AP beacon message 922 may be used to carry ESL information, such as to indicate ESL information and/or address information for encrypted ESL address generation, as described with reference to FIGS. 5-8, and as described further with reference to diagram 902.

The encrypted AD MIC field 916 includes message integrity check (MIC) information for security and optionally error correction. The encrypted AD MIC field 916 may include an encrypted string used to verify the veracity of the payload information of the AD payload field 914.

The AP beacon message 922 may include an ESL payload, as illustrated in diagram 902. In the example of FIG. 9, diagram 902 illustrates an example of an ESL payload including multiple commands. The example of the ESL payload of FIG. 9 includes a group ID field 932 and a plurality of commands, such as length command values (LCVs) 934-942. Although five commands are illustrated in the example of FIG. 9, additional commands or fewer commands may be included in other implementations. Additionally, although LCV commands or command format is used in the example of FIG. 9, other command formats may be used, in addition to or in place of the LCV format. As illustrated in the example of FIG. 9, each command may have a different size.

Each command, LCV, may indicate address information or address generation information as described above. For example, each LCV may include a common or public address for an ESL AP or a unique sequence or value for the ESL AP which may be sued to generate the dynamic and secure ESL address for the ESL for inclusion in an ESL beacon start transmission/synchronization packet.

Additionally, or alternatively, each command, LCV, may be associated with a particular ESL controller or radio. For example, each LCV may include a unique identifier for a particular ESL controller/radio or group of ESLs. The unique identifier may be provided to the ESL controller as address generation information for the generation of the dynamic and secure ESL address for inclusion in an ESL beacon.

In other implementations, the ESL payload includes separate command mapping information which is distinct from the commands (LCVs). The command mapping information may include or correspond to a bitmap which maps ESL controllers to commands. The bitmap may utilize an order or listing of ESL controllers as in a Group ID (group ID information) to indicate the ESL controllers. For example, a bitmap that indicates values of 0, 4, 7, 32, and 63 for an ESL group with a value of 01 may indicate the first, fifth, eighth, thirty-third, and sixty-fourth ESL controllers of a second ESL group (with a group ID of 01) as indicated by ESL group information. The ESL group information may be pre-configured and/or sent as part of the configuration information.

Diagram 904 illustrates an example of an LCV format, such as an ESL LCV format for the LCVs of diagram 902. As depicted by diagram 904, the ESL LCV format may include a length field 952, a command field 954, and a parameters field 962. The length field 952 may indicate a length of the command field 954 and/or parameters field 962 and generally indicates a location of a command and where to find (e.g., the location of) a next command. The command field 954 may indicate or identify the type of command, such as a type of ESL command. The parameters field 962 may provide parameter information for or associated with the command indicated by the command field 954.

Additionally, or alternatively, the LCV may include a unique identifier for each of the ESL radios. In some such implementations, this unique identifier is provided as input to the generator function for obtaining an encrypted address, such as encrypted address ‘B’. In a particular implementation, the unique identifier may be sent as a bitmap in the same order of ESLs that are represented by the Group ID.

As an illustrative non-limiting example, an ESL AP broadcasts a beacon start transmission with a unique bit pattern (‘A’) in its payload which is received by a set of ESL controller/radios. Each ESL controller/radio may then generate a dynamic encrypted address (‘B’) using the unique bit pattern (‘A’) and some configured information or stored device information, such as its own MAC address (‘M’).

The address generating function may be an encryption scheme or random sequence generate (e.g., pseudo-random sequence generator (‘p’)), such that the dynamic encrypted address (‘B’) is generated by the following equation B=p (A, M).

In some implementations, the generating function may be based on AES encryption, such that dynamic encrypted address (‘B’) is the ciphertext obtained after encrypting a plaintext that is a function of the address generation information (‘A’) periodically provided by the ESL AP and the static or semi-static device information, MAC address (‘M’).

Non-ESL devices may receive multiple ESL radio beacons and extract the dynamic encrypted addresses (‘B’s′) from the beacons, and measure the ESL beacons. The non-ESL device then associate the measurements with the addresses for position determination by the non-ESL device using received address mapping information, as described in FIG. 6, or the non-ESL devices transmits the information to the ESL network for network based position determination, as described in FIG. 7.

In some implementations, the LCV contains address information, such as address ‘A’. The address information may include or correspond to dynamic, public ESL address information or address generation seed information which is used by an ESL device to generate a dynamic and encrypted ESL address, such as encrypted address ‘B’. The address information of the LCV may be derived at the ESL server (e.g., private server) and then communicated to the ESL APs. The address information of the LCV may change from over time, such as each duty cycle, to be constantly time-evolving so that encrypted ESL radio addresses (‘B’) always appear to be changing over time (time-evolving) as well.

In some implementations, the ESL system may use time-slot index information. For example, time-slot index information may be used in addition to or in place of the ESL MAC address, and the dynamic address ‘B’ can be generated using a function with inputs of the address information from the ESL AP ‘A’ and the time-slot index of a beacon transmission or beacon start transmission. When combined with, AES-based generation approaches, the time-slot index can be interpreted as a ‘counter’, which updates the plaintext every time slot, such as new ‘A’=original ‘A’+time_slot_index.

In some implementations, the ESL system may use a privately known ESL identifier (‘I’). For example, during installation and/or configuration of the ESL infrastructure, each ESL device (e.g., AP, radio/controller, or both) may be associated with the privately known ESL identifier (‘I’), such as a unique identifier (e.g., sequence of bits) for the device. The privately known ESL identifier (‘I’) may then used by the ESL device to generate its corresponding dynamic address. In a particular implementation, the privately known ESL identifier (‘I’) may also be directly sent as part of the ESL AP beacon (along with ‘A’).

In some implementations, the ESL system may use address garbling. For example, the ESL system may intentionally garble some addresses periodically to disrupt the ability or performance of external entities that employ crowdsourcing to data mine or gain information on the ESL. To illustrate, an ESL server and/or AP may assign the same address ‘A’ and/or the same the privately known ESL identifier ‘I’ to different ESL radios, but in different time slots. The ESL server can then map back the resultant addresses ‘B’ to the correct the garbled ESL radio locations. However, to an external entity, the data collected over time to access the ESL system would include measurements from different ESLs would be treated as being from the same ESL, which would degrade performance and/or improve ESL security.

In some implementations, the ESL system may use additional techniques to improve the security and secure address generation robustness for device-based positioning. For example, a time-varying key may be used in dynamic address ‘B’ generation to improve or ensure that an external entity cannot learn and ‘crack’ the address generation or encryption (e.g., AES encryption) with a sufficient number of addresses that are gathered over time. The time-varying key would also ensure that even if a specific ‘survey’ device is able to extract mapping information and identify the ESL locations, other regular ‘test’ devices would be unable to identify the ESL locations without subscribing to the ESL server's services (which in turn may prevent regular ‘test’ devices from disclosing the ESL locations externally).

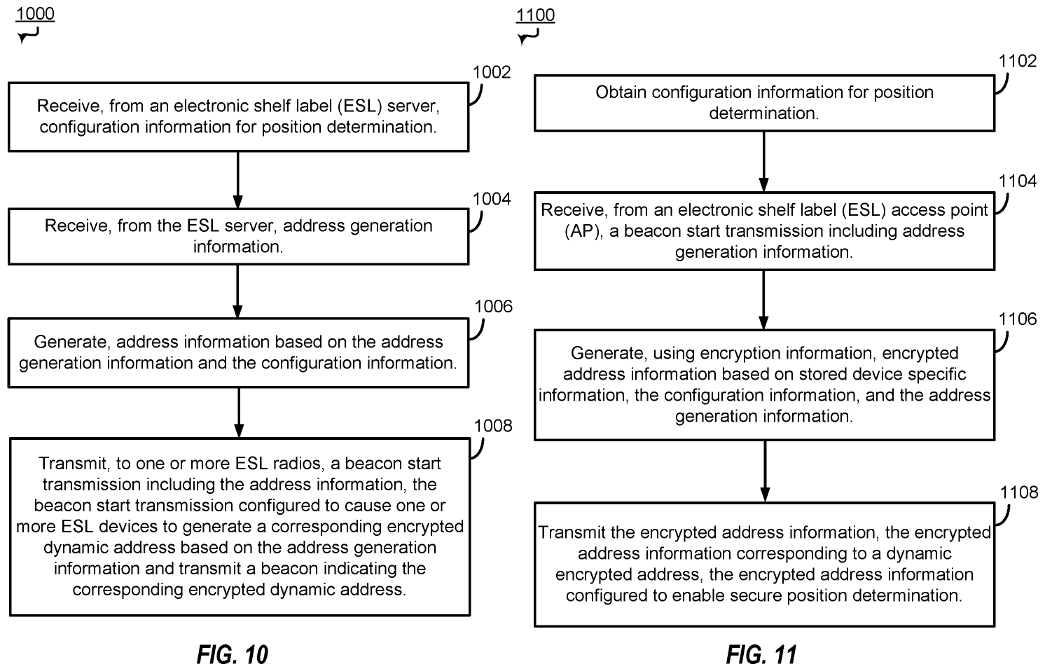

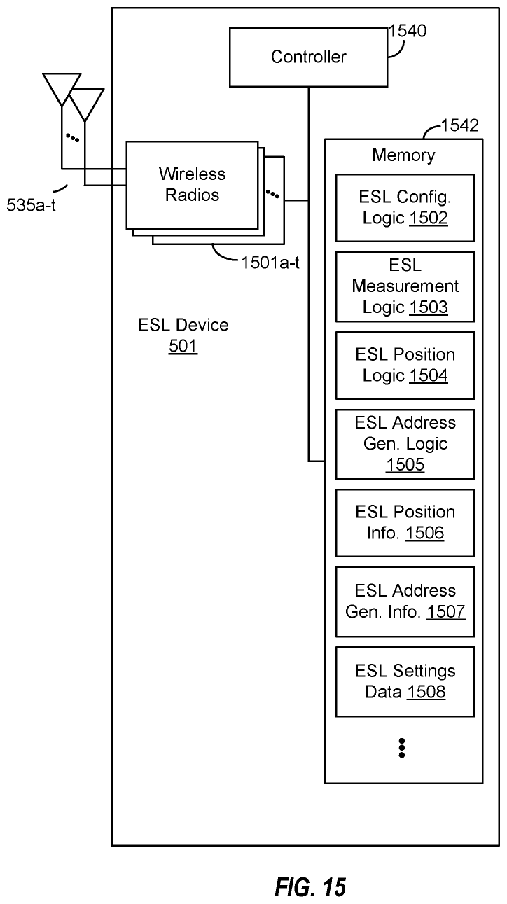

FIG. 10 is a flow diagram 1000 illustrating example blocks executed by wireless communication device (e.g., an ESL device or a UE) configured according to an aspect of the present disclosure. The example blocks will also be described with respect to ESL device 501 as illustrated in FIG. 15. FIG. 15 is a block diagram illustrating ESL device 501 configured according to one aspect of the present disclosure. ESL device 501 includes the structure, hardware, and components as illustrated for ESL device 501 of any of FIG. 5. For example, ESL device 501 includes controller/processor 1540, which operates to execute logic or computer instructions stored in memory 1542, as well as controlling the components of ESL device 501 that provide the features and functionality of ESL device 501. ESL device 501, under control of controller/processor 240, transmits and receives signals via wireless radios 1501a-t and antennas 535a-t. As illustrated in the example of FIG. 15, memory 1542 stores one or more of ESL configuration logic 1502, ESL measurement logic 1503, ESL position logic 1504, ESL address generation logic 1505, ESL position information 1506, ESL address generation information 1507, or ESL settings data 1508. The data (1502-1508) stored in the memory 242 may include or correspond to data and/or logic to enable the operations of FIGS. 5-8.

At block 1002, a wireless communication device, such as an ESL device (e.g., an ESL AP), receives, from an ESL server, configuration information for position determination. The configuration information may include or correspond to configuration information of the configuration transmission 550, such as the ESL settings information 546 thereof, of FIG. 5, the configuration information transmitted at 610 of FIG. 6, the configuration information transmitted at 710 of FIG. 7, or the configuration information transmitted at 830 of FIG. 8. The position determination may include or correspond to the secure ESL positioning determination for non-ESL devices where the ESL devices use dynamic and encrypted addresses for ESL transmission of FIGS. 5-9. For example, the ESL device 501 transmits the configuration transmission 550 for dynamic address configuration for ESL devices, such as ESL devices 591, to the ESL devices 591. As another example, an ESL AP, such as ESL AP 604 or 704, receives the configuration information from the ESL server 602 or 702 at 610, 710.

At block 1004, the wireless communication device receives, from the ESL server, address generation information. The address generation information may include or correspond to the address generation information 509 of FIG. 5 or the address generation information sent at 615 of FIG. 6 or 715 of FIG. 7. For example, the ESL device 501 transmits address generation information 509 for dynamic address configuration for ESL devices, such as ESL devices 591, to the ESL devices 591. As another example, an ESL AP, such as ESL AP 604 or 704, receives the address generation information from the ESL server 602 or 702 at 615, 715.

At block 1006, the wireless communication device generates, address information based on the address generation information and the configuration information. The address information may include or correspond to the address information 508 of FIG. 5. For example, the ESL device 501 transmits address generation information 509 for dynamic address configuration for ESL devices, such as ESL device 591, to the ESL devices 591. As another example, an ESL AP, such as ESL AP 604 or 704, determines, at 620 or 720, an encrypted address for the ESL AP (e.g., for inclusion in a beacon start transmission sent thereby) or address generation information for one or more ESL controllers (e.g., ESL controller 606 or 706) based on the address generation information and the configuration information received from the ESL server 602 or 702.

At block 1008, the wireless communication device transmits, to one or more ESL radios, a beacon start transmission including the address information, the beacon start transmission configured to cause one or more ESL devices to generate a corresponding encrypted dynamic address based on the address generation information and transmit a beacon indicating the corresponding encrypted dynamic address. The beacon start transmission may include or correspond to the beacon start transmissions at 625 or 725 of FIG. 6 or 7, and the ESL radios may include or correspond ESL devices of the ESL devices 591, the ESL controller 606, or the ESL controller 706. For example, the ESL device 501 or an ESL device of the ESL devices 591 transmits a beacon start transmission which causes the ESL device 501 or ESL devices of the ESL devices 591 to transmit the beacons 554. As another example, an ESL AP, such as ESL AP 604 or 704, transmits, at 625 or 725, a beacon start transmission including the address information generated based on the received address generation information from the ESL server 602 or 702.

The wireless communication device (e.g., UE or ESL device) may execute additional blocks (or the wireless communication device may be configured further to perform additional operations) in other implementations. For example, the wireless communication device, such as one or more processors and one or more memories (e.g., a processing system) thereof, may perform one or more operations described above, such as described with reference to FIGS. 5-8 or as described below. As another example, the wireless communication device may perform one or more aspects as presented below.

In some implementations, the address generation information corresponds to a top level address associated with the device, and wherein the address information corresponds to a derived and encrypted address associated with the device.

In some implementations, the configuration information includes or corresponds to information encryption information, dynamic address generation configuration information, or both. In some implementations, the address generation information includes or corresponds to a unique sequence value.

In some implementations, the at least one processor is further configured to: receive, from the ESL server, second address generation information; generate second address information based on the second address generation information and the configuration information, the second address information indicating a second address different from a first address indicated by the address information; transmit, to one or more ESL radios, a second synchronization transmission including the second address information; and transmit, to one or more ESL radios, a second synchronization transmission including the second address information, the second synchronization transmission configured to cause the one or more ESL devices to generate a corresponding second encrypted dynamic address based on the second address generation information and transmit a beacon indicating the corresponding second encrypted dynamic address.

In some implementations, the device corresponds to an ESL device of a first ESL group wherein the at least one processor is further configured to: obtain generator function information including a plurality of generator functions for determining dynamic encrypted address information and key rotation information for adjusting dynamic encrypted address information; communicate with an ESL device of a second ESL group; receive an indication of a particular generator function of a set of generator functions of the generator function information and an indication of one or more key rotation parameters of the key rotation information; select a second particular generator function of the set of generator functions and one or more second key rotation parameters of the key rotation information based on the particular generator function and the one or more key rotation parameters; and transmit, by the ESL device, an indication of the second particular generator function and of an indication of the one or more second key rotation parameters to other ESL devices of the first group.

In some implementations, the one or more second key rotation parameters include: a common key; 100 bits of a current timestamp followed by 28 bits having a value of zero; or 128 bits of a current timestamp.

Accordingly, wireless communication devices may perform secure ESL position determination and ESL position based notifications to enable secure position or location based operations. Accordingly, the network performance and user experience may be increased due to secure ESL based position determination and ESL position based notifications.

FIG. 11 is a flow diagram 1100 illustrating example blocks executed by wireless communication device (e.g., a UE or a ESL device) configured according to an aspect of the present disclosure. The example blocks of FIG. 11 will also be described with respect to ESL device 501 as illustrated in FIG. 16. The example blocks of FIG. 11 may be practiced by any of the ESL devices described herein.

At block 1102, a wireless communication device, such as an ESL device (e.g., ESL controller/radio), obtains configuration information for position determination. The configuration information may include or correspond to configuration information of the configuration transmission 550, such as the ESL settings information 546 thereof, of FIG. 5, the configuration information transmitted at 610 of FIG. 6, the configuration information transmitted at 710 of FIG. 7, or the configuration information transmitted at 830 of FIG. 8. For example, the ESL device 501 transmits the configuration transmission 550 for dynamic address configuration for ESL devices, such as ESL device 591. As another example, the ESL controllers, such as ESL controller 606 or 706, receive the configuration information from the ESL server 602 or 702 (and relayed by the ESL AP 604 or 704) at 610, 710.

At block 1104, the wireless communication device receives, from an ESL AP, a beacon start transmission including address generation information. The address generation information may include or correspond to address generation information 509 of FIG. 5 or the address generation information sent at 625 of FIG. 6 or 725 of FIG. 7 in a beacon start transmission, and the ESL AP may include or correspond to the ESL device 501 or an ESL device of the ESL devices 591 of FIG. 5, or an ESL AP as described with reference to FIGS. 6-8. For example, the ESL device 501 transmits a beacon start transmission which triggers the beacons 554 by the ESL devices 591. As another example, the ESL controllers, such as ESL controller 606 or 706, receive a beacon start transmission from the ESL AP 604 or 704 at 625, 725 including an encrypted address of the ESL AP to be used for encrypted address generation or including address generation seed information to be used for encrypted address generation for the ESL controller.

At block 1106, the wireless communication device generates, using encryption information, encrypted address information based on stored device specific information, the configuration information, and the address generation information. The encryption information may include or correspond to an encryption technique or cypher of the address generation information 509. The encrypted address information may include or correspond to the encrypted address of the address information 508 and/or of the transmitting device in the beacons 554, the beacons at 635, or the beacons at 735. For example, the ESL device 501 or ESL devices 591 transmit beacons 554 including an encrypted address for the transmitting device which was generated based on an encryption scheme, received data from the ESL network and stored device data, as described with reference to FIGS. 5-7. As another example, the ESL controllers, such as ESL controller 606 or 706, each generate, at 630, 730, an encrypted address to be used for beacons at 635, 735 based on the address generation of the received beacon start transmission from the ESL AP.

At block 1108, the wireless communication device transmits the encrypted address information, the encrypted address information corresponding to a dynamic encrypted address, the encrypted address information configured to enable secure position determination. The encrypted address information may include or correspond to the address information 508 and for an encrypted address of a transmitting device the beacons 554 of FIG. 5 or the encrypted addresses determined at 630 or 730 for beacons at 635 or 735 of FIG. 6 or 7. For example, the ESL device 501 and/or ESL devices 591 may transmit beacons 554 including an encrypted transmission address of the address information 508. As another example, the ESL controllers, such as ESL controller 606 or 706, each transmit, at 635, 735, beacons with an encrypted transmission address.

The wireless communication device (e.g., such as a UE or base station) may execute additional blocks (or the wireless communication device may be configured further to perform additional operations) in other implementations. For example, the wireless communication device may perform one or more operations as described with reference to FIGS. 5-8 or as described below. As another example, the wireless communication device may perform one or more aspects as described above with reference to FIG. 10 or one or more aspects as presented below.

In some implementations, the address generation information corresponds to an encrypted address associated with the ESL AP, and wherein the encrypted address information corresponds to a derived and encrypted address associated with the device.

In some implementations, the encrypted address information is generated based on the address generation information and based on time slot index information associated with the beacon start transmission.

In some implementations, the at least one processor is further configured to: obtain a unique identifier for the device for an ESL system, and wherein the encrypted address information is generated further based on the unique identifier.

In some implementations, the unique identifier is received in the beacon start transmission. In some implementations, the configuration information intentionally maps two ESL devices of an ESL system to a same address to garble ESL system addresses to outside devices.

In some implementations, the at least one processor is further configured to: receive time varying key information from the ESL AP, and wherein the encrypted address information is generated further based on the time varying key information.

In some implementations, the beacon start transmission is transmitted within a Bluetooth ESL synchronization packet. In some implementations, the beacon start transmission includes an ESL payload which includes one or more commands, wherein the one or more command comprises LCVs.

In some implementations, each commands indicates address generation information for a particular ESL group. In some implementations, multiple ESL APs transmit the same commands.

In some implementations, the address generation information is generated by and received from the ESL server periodically. In some implementations, each commands indicates address generation information for a particular ESL device.

In some implementations, each command of the one or more commands is associated with a particular ESL group and a particular device of the particular ESL group, and wherein each command of the one or more commands is arranged in an order which corresponds to an order of the corresponding associated device of the particular ESL group.

In some implementations, the address generation information includes or corresponds to a unique sequence value. In some implementations, the stored device specific information includes or corresponds to a public address or a static address associated with the device. In some implementations, the stored device specific information is a static address and corresponds to a medium access control (MAC) address of the device.

In some implementations, the encrypted address information is further generated based on a private key received from the ESL AP or an ESL server. In some implementations, the encrypted address information changes each duty cycle or each synchronization transmission. In some implementations, the encryption information corresponds to a private key.

In some implementations, the at least one processor is further configured to: receive, from the ESL AP, a second beacon start transmission including the address generation information; generate, using the encryption information, second encrypted address information based on the stored device specific information and the address generation information; and transmit the second encrypted address information, the second encrypted address information indicating a second address different from a first address indicated by the encrypted address information.

In some implementations, the at least one processor is further configured to: receive, from the ESL AP, a second beacon start transmission including second address generation information different from the address generation information; generate, using the encryption information, second encrypted address information based on the stored device specific information and the second address generation information; and transmit the second encrypted address information, the second encrypted address information indicating a second address different from a first address indicated by the encrypted address information.

In some implementations, the encryption information corresponds to AES encryption information, and wherein the AES encryption information is used to perform AES encryption based on the stored device specific information and the address generation information to generate the encrypted address information.

In some implementations, the encryption information corresponds to a random or pseudo-random sequence generator configured to perform random or pseudo-random encryption based on the stored device specific information and the address generation information to generate the encrypted address information.

In some implementations, the device corresponds to an ESL device of a first ESL group wherein the at least one processor is further configured to: obtain generator function information including a plurality of generator functions for determining dynamic encrypted address information and key rotation information for adjusting dynamic encrypted address information; communicate with an ESL device of a second ESL group; receive an indication of a particular generator function of a set of generator functions of the generator function information and an indication of one or more key rotation parameters of the key rotation information; select a second particular generator function of the set of generator functions and one or more second key rotation parameters of the key rotation information based on the particular generator function and the one or more key rotation parameters; and transmit, by the ESL device, an indication of the second particular generator function and of an indication of the one or more second key rotation parameters to other ESL devices of the first group.

In some implementations, the one or more second key rotation parameters include: a common key; 100 bits of a current timestamp followed by 28 bits having a value of zero; or 128 bits of a current timestamp.

Accordingly, wireless communication devices may perform secure ESL position determination and ESL position based notifications to enable secure position or location based operations. Accordingly, the network performance and user experience may be increased due to secure ESL based position determination and ESL position based notifications.

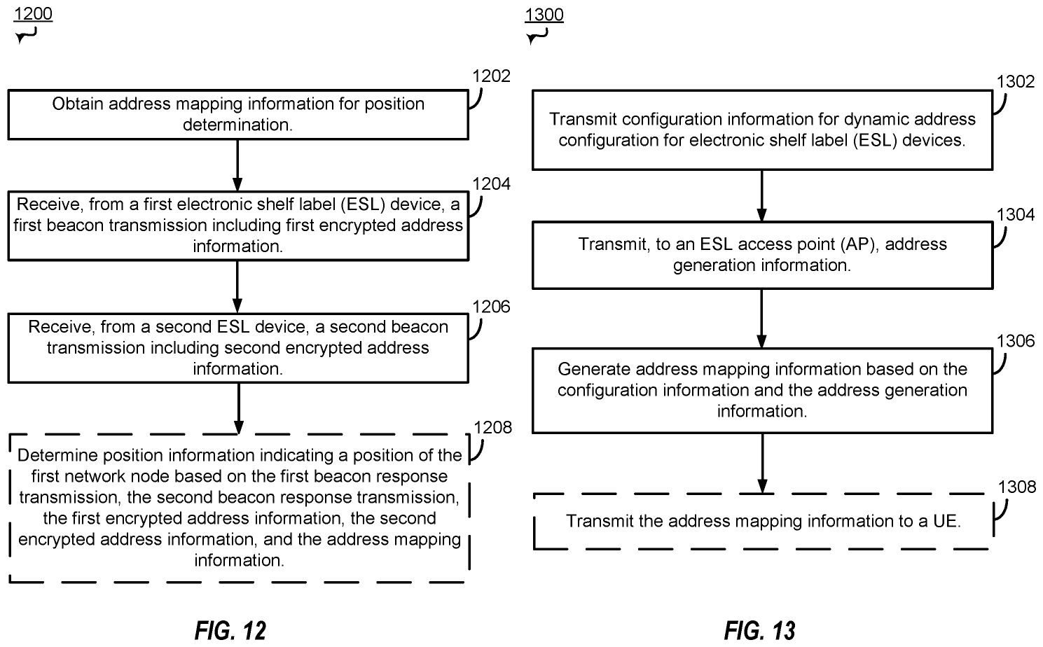

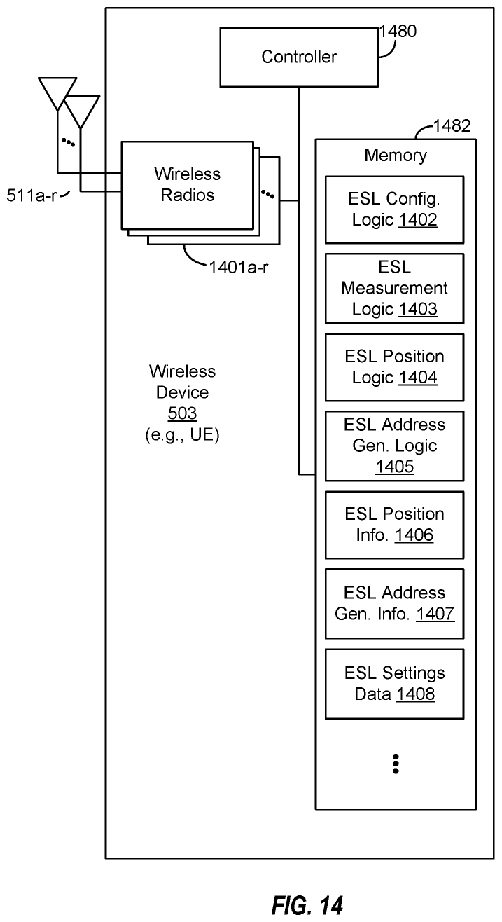

FIG. 12 is a flow diagram 1200 illustrating example blocks executed by a wireless communication device (e.g., a UE or an ESL device) configured according to an aspect of the present disclosure. The example blocks will also be described with respect to wireless device 503 as illustrated in FIG. 14. FIG. 14 is a block diagram illustrating wireless device 503 configured according to one aspect of the present disclosure. Wireless device 503 includes the structure, hardware, and components as illustrated for wireless device 503 of FIG. 5. For example, wireless device 503 includes controller/processor 1480, which operates to execute logic or computer instructions stored in memory 1482, as well as controlling the components of wireless device 503 that provide the features and functionality of wireless device 503. Wireless device 503, under control of controller/processor 1480, transmits and receives signals via wireless radios 1401a-r and antennas 511a-r. As illustrated in the example of FIG. 14, memory 1482 stores one or more of ESL configuration logic 1402, ESL measurement logic 1403, ESL position logic 1404, ESL address generation logic 1405, ESL position information 1406, ESL address generation information 1407, or ESL settings data 1408. The data (1402-1408) stored in the memory 1482 may include or correspond to data and/or logic to enable the operations of FIGS. 5-8.

At block 1202, a wireless communication device, such as a UE, obtains address mapping information for position determination. The address mapping information may include or correspond to address mapping information 544 of FIG. 5, the address mapping information transmitted at 640 of FIG. 6, or the address mapping information generated at 735 of FIG. 7. For example, the wireless device 503 receives the address mapping information 544 in the mapping information transmission 552 from the ESL device 501 or an ESL device of the ESL devices 591 of FIG. 5, or the device 608 receives the address mapping information from the ESL server 602 (e.g., relayed by the ESL AP 604) at 640 of FIG. 6.

At block 1204, the wireless communication device receives, from a first ESL device, a first beacon transmission including first encrypted address information. The first beacon transmission may include or correspond to beacon signals or beacon response signals, as described with reference to FIGS. 5-8, such as a beacon of the beacons 554 of FIG. 5, the beacons 635 of FIG. 6, or the beacons 735 of FIG. 7, and the first encrypted address information may include or correspond to the address information 508 and/or the indicated transmission address of the beacon signals, as described with reference to FIGS. 5-8. For example, the wireless device 503 receives a beacon of the beacons 554 from the ESL device 501 or an ESL device of the ESL devices 591, as described with reference to FIG. 5. As another example, the device 608 or 708 receives beacons at 635, 735, from a first ESL controller (e.g., ESL controller 606 or 706) including a transmission address that corresponds to a dynamic and encrypted address.

At block 1206, the wireless communication device receives, from a second ESL device, a second beacon transmission including second encrypted address information. The second beacon transmission may include or correspond to second beacon signals or beacon response signals, as described with reference to FIGS. 5-8, such as a beacon of the beacons 554 of FIG. 5, the beacons 635 of FIG. 6, or the beacons 735 of FIG. 7, and the second encrypted address information may include or correspond to the address information 508 and/or the indicated transmission address of the second beacon signals, as described with reference to FIGS. 5-8. For example, the wireless device 503 receives a second beacon of the beacons 554 from a second ESL device different from the first ESL device, such as the ESL device 501 or an ESL device of the ESL devices 591, as described with reference to FIG. 5. As another example, the device 608 or 708 receives beacons at 635, 735, including a transmission address that corresponds to a dynamic and encrypted address. As another example, the device 608 or 708 receives beacons at 635, 735, from a second ESL controller (e.g., ESL controller 606 or 706) including a transmission address that corresponds to a dynamic and encrypted address.

At block 1208, the wireless communication device optionally determines position information indicating a position of the device based on the first beacon transmission, the second beacon transmission, the first encrypted address information, the second encrypted address information, and the address mapping information. The position information may include or correspond to device position information 543 of FIG. 5, the position information determined and transmitted at 650 and 655 of FIG. 6, or the position information determined 755 of FIG. 7. The position information may include or correspond to a position of a non-ESL device, such as UE, including ESL device 501 of FIG. 5, device 608 of FIG. 6, etc. For example, the wireless device 503 may determine and transmit the device position information 543 indicating a position of the wireless device 503 in the positioning information transmission 556 to the ESL network (e.g., ESL device 501 or ESL devices 591) based on the measurement information 542 and based on the address mapping information 544, as described with reference to FIG. 5. As another example, the device 608 determines the position information at 650 of FIG. 6, based on the address mapping information received at 640 and the measurements from measurement the beacons at 645.

After block 1208, the wireless communication device may use the determined position information. For example, the wireless device 503 may use the determined position internally, and/or transmit a request to the ESL network for a position or location based notification, as described with reference to FIGS. 5 and 6.

In other implementations, wireless communication device may not determine the position information based on the measurement information. In such implementations, the wireless communication device may not receive the address mapping information, and the wireless communication device may transmit the measurement information to the ESL network for determination of the position information indicating the position of the wireless communication device, as described with reference to FIG. 7. For example, the device 708 transmits the measurement information at 750, and the ESL network, such as the ESL server 702 thereof, determines the position information at 755 of FIG. 7, based on the address mapping information generated at 740 and the measurement information received at 750.

The wireless communication device (e.g., UE or ESL device) may execute additional blocks (or the wireless communication device may be configured further to perform additional operations) in other implementations. For example, the wireless communication device may perform one or more operations described above, such as described with reference to FIGS. 5-8 or described below. As another example, the wireless communication device may perform one or more aspects as described with reference to FIGS. 10 and 11 and as presented below.

In some implementations, the at least one processor is further configured to: measure the first and second beacon transmissions to generate measurement information, when the position information is determined based the measurement information;

In some implementations, the at least one processor configured to measure the first and second beacon transmissions includes to: calculate one or more of a received signal strength indicator (RSSI), a reference signal received power (RSRP), or an angle-of-arrival (AoA), of the first beacon transmission and the second beacon transmission; and determine the position information based on one or more of the RSSI, the RSRP, or the AoA of the first beacon transmission and the second beacon transmission.

In some implementations, the address mapping information includes association information for mapping device addresses to device positions. In some implementations, the address mapping information correspond to association information which identifies an encrypted ESL radio address of an ESL beacon with a position and enables generation of the position information.

In some implementations, the at least one processor is further configured to: identify a first position of the first ESL device based on the first encrypted address information and the address mapping information; and identify a second position of the second ESL device based on the second encrypted address information and the address mapping information, and wherein the position information is determined based on the first position of the first ESL device and the second position of the second ESL device.

In some implementations, the address mapping information corresponds to association information which identifies a decrypted ESL radio address, and wherein the at least one processor is further configured to: receive a private key; decrypt the first encrypted address information to generate first address information; and identify a first position of the first ESL device using the first address information and the address mapping information, and wherein the position information is determined based on the first position of the first ESL device.

In some implementations, the at least one processor is further configured to: transmit the position information to an ESL device; and receive a notification from the ESL device responsive to transmission of the position information.

In some other implementation, the at least one processor is configured to: receive, from a first electronic shelf label (ESL) device, a first beacon transmission including first encrypted address information; receive, from a second ESL device, a second beacon transmission including second encrypted address information; measure the first and second beacon transmissions to generate measurement information; and transmit the measurement information, wherein the measurement information includes a first measurement for the first beacon transmission associated with the first encrypted address information and a second measurement for the second beacon transmission associated with the second encrypted address information.

In some such implementations, the at least one processor is configured to measure the first and second beacon transmissions includes to: calculate one or more of a received signal strength indicator (RSSI), a reference signal received power (RSRP), or an angle-of-arrival (AoA), of the first beacon transmission and the second beacon transmission; and generate the measurement information based on one or more of the RSSI, the RSRP, or the AOA.

In some such implementations, the measurement information includes one or more of a received signal strength indicator (RSSI), a reference signal received power (RSRP), or an angle-of-arrival (AoA), of the first beacon transmission and the second beacon transmission.

Accordingly, wireless communication devices may perform secure ESL position determination and ESL position based notifications to enable secure position or location based operations. Accordingly, the network performance and user experience may be increased due to secure ESL based position determination and ESL position based notifications.

FIG. 13 is a flow diagram 1300 illustrating example blocks executed by a wireless communication device (e.g., a UE or ESL device) configured according to an aspect of the present disclosure. The example blocks of FIG. 13 will also be described with respect to ESL device 501 as illustrated in FIG. 16. The example blocks of FIG. 13 may be practiced by any of the ESL devices described herein.

At block 1302, a wireless communication device, transmits configuration information for dynamic address configuration for ESL devices. The configuration information may include or correspond to configuration information of the configuration transmission 550, such as the ESL settings information 546 thereof, of FIG. 5, the configuration information transmitted at 610 of FIG. 6, the configuration information transmitted at 710 of FIG. 7, or the configuration information transmitted at 830 of FIG. 8. For example, the ESL device 501 transmits configuration information for dynamic address configuration for ESL devices. As another example, the ESL server 602 or 702 transmits configuration information at 610, 710.

At block 1304, the wireless communication device transmits, to ESL AP, address generation information. The address generation information may include or correspond to address generation information 509 of FIG. 5 or the address generation information sent at 615 of FIG. 6 or 715 of FIG. 7, and the ESL AP may include or correspond to the ESL device 501 or an ESL device of the ESL devices 591 of FIG. 5, or an ESL AP as described with reference to FIGS. 6-8. For example, the ESL device 501 generates the address generation information 509 based on the ESL settings information 546. The beacons 554 may be sent based on the address generation information 509. As another example, the ESL server 602 or 702 transmits address generation information (e.g., an address of the ESL server or address seed information) at 615, 715 to one or more ESL devices, such as the ESL AP 604 or 704.

At block 1306, the wireless communication device generates address mapping information based on the configuration information and the address generation information. The address mapping information may include or correspond to address mapping information 544 of FIG. 5, the address mapping information transmitted at 640 of FIG. 6, or the address mapping information generated at 735 of FIG. 7. For example, the ESL device 501 generates address mapping information 544 based on the ESL settings information 546 of the configuration transmission 550 and the address generation information 509. As another example, the ESL server 602 or 702 generates address mapping information at 640, 740 based on the configuration information transmitted at 610, 710 and the address information or address generation information transmitted at 615, 715.

At block 1308, the wireless communication device optionally transmits the address mapping information to a UE. The UE may include or correspond to the wireless device 503 of FIG. 5, the device 608 of FIG. 6, the device 708 of FIG. 7, or the device 806 of FIG. 8. For example, the ESL device 501 may transmit the address mapping information to 544 to the wireless device 503 in the mapping information transmission 552. As another example, the ESL server 602 transmits address generation information at 640 based on the configuration information transmitted at 610 and the address information or address.

In other implementations, the wireless communication device does not transmit the address mapping information to a UE, ESL devices, or non-ESL devices. In such implementations, the wireless communication device receives measurement information for a device (e.g., UE or non-ESL device), which may be relayed to it by an ESL device or devices, and determines a position for the device based on the received measurement information and the generated address mapping information, as described with reference to FIGS. 5, 7, and 8. For example, the ESL server 702 generates address mapping information at 740 based on the configuration information transmitted at 710 and the address information or address generation information transmitted at 715, and uses the address mapping information and the received measurement information at 750 to determine the position information at 755.

The wireless communication device (e.g., UE or base station) may execute additional blocks (or the wireless communication device may be configured further to perform additional operations) in other implementations. For example, the wireless communication device may perform one or more operations described above, such as described with reference to FIGS. 5-8 and any of the operations described below. As another example, the wireless communication device may perform one or more aspects as described with reference to FIGS. 10-12 or as presented below.

In some implementations, the configuration information is broadcast to multiple ESL devices including ESL radios and ESL APs. Additionally, or alternatively, the address generation information is broadcast to multiple ESL APs.

In some implementations, the at least one processor is further configured to: receive, from the UE and responsive to the mapping information, position information indicating a position of the UE.

In some implementations, the at least one processor is further configured to: receive, from the UE, an ESL position related request; determine notification information for the UE based on the ESL position related request and the position information; transmit a notification to the UE based on the notification information.

In some implementations, the at least one processor is further configured to: receive, from the UE, an ESL position related request; determine notification information for the UE based on the ESL position related request and the position information; and transmit notification instruction information to one or more ESL devices configured to cause the one or more ESL devices to output visual or audio notifications for the UE based on the notification information.

In some implementations, the at least one processor is further configured to: transmit, to the ESL and one or more second ESL APs, second address generation information; generate second address mapping information based on the configuration information and the second address generation information; transmit the second address mapping information to the UE; and receive second position information from the UE indicating a second position of the UE.

In some implementations, the configuration information includes or corresponds to information encryption information, dynamic address generation configuration information, or both. In some implementations, the address generation information includes or corresponds to a unique sequence value.

In some implementations, the device corresponds to an ESL device of a first ESL group wherein the at least one processor is further configured to: obtain generator function information including a plurality of generator functions for determining dynamic encrypted address information and key rotation information for adjusting dynamic encrypted address information; communicate with an ESL device of a second ESL group; receive an indication of a particular generator function of a set of generator functions of the generator function information and an indication of one or more key rotation parameters of the key rotation information; select a second particular generator function of the set of generator functions and one or more second key rotation parameters of the key rotation information based on the particular generator function and the one or more key rotation parameters; and transmit, by the ESL device, an indication of the second particular generator function and of an indication of the one or more second key rotation parameters to other ESL devices of the first group.

In some implementations, the one or more second key rotation parameters include: a common key; 100 bits of a current timestamp followed by 28 bits having a value of zero; or 128 bits of a current timestamp.

In some other implementations, at least one processor is configured to: transmit configuration information for position determination by dynamic address; transmit, to an electronic shelf label (ESL) access point (AP), address generation information; generate address mapping information based on the configuration information; transmit the address mapping information to a UE; receiving, from the UE, measurement information, wherein the measurement information includes a first measurement for a first beacon transmission associated with a first encrypted address information of a first ESL device and a second measurement for a second beacon transmission associated with a second encrypted address information of a second ESL device; and determine position information indicating a position of the UE based on the measurement information, the mapping information, the first encrypted address information, and the second encrypted address information.

In some such implementations, the measurement information includes one or more of a received signal strength indicator (RSSI), a reference signal received power (RSRP), or an angle-of-arrival (AoA), of the first beacon transmission and the second beacon transmission.

Accordingly, wireless communication devices may perform secure ESL position determination and ESL position based notifications to enable secure position or location based operations. Accordingly, the network performance and user experience may be increased due to secure ESL based position determination and ESL position based notifications.

In the implementations described herein, an ESL system or network may include an ESL cloud server, one or more ESL gateway servers or edge servers associated with the ESL cloud server, one or more ESL APs associated with each gateway or edge server, one or more ESL controllers associated with each ESL AP, one or more ESLs associated with each ESL controller, and one or more ESL tags associated with each ESL. In some implementations, the ESL system may include a plurality of energizers, which may be associated with multiple ESL tags of the plurality of the ESL tags.

In a first aspect, a device for wireless communication includes: at least one processor; and a memory coupled to the at least one processor, wherein the at least one processor is configured to cause the device to: receive, from an electronic shelf label (ESL) server, configuration information for position determination; receive, from the ESL server, address generation information; generate, address information based on the address generation information and the configuration information; and transmit, to one or more ESL radios, a beacon start transmission including the address information, the beacon start transmission configured to cause one or more ESL devices to generate a corresponding encrypted dynamic address based on the address generation information and transmit a beacon indicating the corresponding encrypted dynamic address.

In a second aspect, alone or in combination with the first aspect, the address generation information corresponds to a top level address associated with the device, and wherein the address information corresponds to a derived and encrypted address associated with the device.

In a third aspect, alone or in combination with one or more of the above aspects, the configuration information includes or corresponds to information encryption information, dynamic address generation configuration information, or both.

In a fourth aspect, alone or in combination with one or more of the above aspects, the address generation information includes or corresponds to a unique sequence value.

In a fifth aspect, alone or in combination with one or more of the above aspects, the at least one processor is further configured to cause the device to: receive, from the ESL server, second address generation information; generate second address information based on the second address generation information and the configuration information, the second address information indicating a second address different from a first address indicated by the address information; transmit, to one or more ESL radios, a second beacon start transmission including the second address information; and transmit, to one or more ESL radios, a second beacon start transmission including the second address information, the second beacon start transmission configured to cause the one or more ESL devices to generate a corresponding second encrypted dynamic address based on the second address generation information and transmit a beacon indicating the corresponding second encrypted dynamic address.

In a sixth aspect, alone or in combination with one or more of the above aspects, a device for wireless communication includes: at least one processor; and a memory coupled to the at least one processor, wherein the at least one processor is configured to: obtain configuration information for position determination; receive, from an electronic shelf label (ESL) access point (AP), a beacon start transmission including address generation information; generate, using encryption information, encrypted address information based on stored device specific information, the configuration information, and the address generation information; and transmit the encrypted address information, the encrypted address information corresponding to a dynamic encrypted address, the encrypted address information configured to enable secure position determination.

In a seventh aspect, alone or in combination with one or more of the above aspects, the address generation information corresponds to an encrypted address associated with the ESL AP, and wherein the encrypted address information corresponds to a derived and encrypted address associated with the device.

In an eighth aspect, alone or in combination with one or more of the above aspects, the encrypted address information is generated based on the address generation information and based on time slot index information associated with the beacon start transmission.

In a ninth aspect, alone or in combination with one or more of the above aspects, the at least one processor is further configured to cause the device to: obtain a unique identifier for the device for an ESL system, and wherein the encrypted address information is generated further based on the unique identifier.

In a tenth aspect, alone or in combination with one or more of the above aspects, the unique identifier is received in the beacon start transmission.

In an eleventh aspect, alone or in combination with one or more of the above aspects, the configuration information intentionally maps two ESL devices of an ESL system to a same address to garble ESL system addresses to outside devices.

In a twelfth aspect, alone or in combination with one or more of the above aspects, the at least one processor is further configured to cause the device to: receive time varying key information from the ESL AP, and wherein the encrypted address information is generated further based on the time varying key information.

In a thirteenth aspect, alone or in combination with one or more of the above aspects, the beacon start transmission is transmitted within a Bluetooth ESL synchronization packet.

In a fourteenth aspect, alone or in combination with one or more of the above aspects, the beacon start transmission includes an ESL payload which includes one or more commands, wherein the one or more command comprises length command values (LCVs).

In a fifteenth aspect, alone or in combination with one or more of the above aspects, each command indicates address generation information for a particular ESL group.

In a sixteenth aspect, alone or in combination with one or more of the above aspects, each command indicates address generation information for a particular ESL device.

In a seventeenth aspect, alone or in combination with one or more of the above aspects, each command of the one or more commands is associated with a particular ESL group and a particular device of the particular ESL group, and wherein each command of the one or more commands is arranged in an order which corresponds to an order of the corresponding associated device of the particular ESL group.

In an eighteenth aspect, alone or in combination with one or more of the above aspects, the stored device specific information includes or corresponds to a public address or a static address associated with the device.

In a nineteenth aspect, alone or in combination with one or more of the above aspects, the stored device specific information is a static address and corresponds to a medium access control (MAC) address of the device.

In a twentieth aspect, alone or in combination with one or more of the above aspects, the encrypted address information is further generated based on a private key received from the ESL AP or an ESL server.

In a twenty-first aspect, the encrypted address information changes each duty cycle or each beacon start transmission.

In a twenty-second aspect, alone or in combination with one or more of the above aspects, the encryption information corresponds to a private key.

In a twenty-third aspect, alone or in combination with one or more of the above aspects, the at least one processor is further configured to cause the device to: receive, from the ESL AP, a second beacon start transmission including the address generation information; generate, using the encryption information, second encrypted address information based on the stored device specific information and the address generation information; and transmit the second encrypted address information, the second encrypted address information indicating a second address different from a first address indicated by the encrypted address information.

In a twenty-fourth aspect, alone or in combination with one or more of the above aspects, the at least one processor is further configured to cause the device to: receive, from the ESL AP, a second beacon start transmission including second address generation information different from the address generation information; generate, using the encryption information, second encrypted address information based on the stored device specific information and the second address generation information; and transmit the second encrypted address information, the second encrypted address information indicating a second address different from a first address indicated by the encrypted address information.

In a twenty-fifth aspect, alone or in combination with one or more of the above aspects, the encryption information corresponds to AES encryption information, and wherein the AES encryption information is used to perform AES encryption based on the stored device specific information and the address generation information to generate the encrypted address information.

In a twenty-sixth aspect, alone or in combination with one or more of the above aspects, the encryption information corresponds to a random or pseudo-random sequence generator configured to perform random or pseudo-random encryption based on the stored device specific information and the address generation information to generate the encrypted address information.

In a twenty-seventh aspect, a device for wireless communication includes: at least one processor; and a memory coupled to the at least one processor, wherein the at least one processor is configured to cause the device to: obtain address mapping information for position determination; receive, from a first electronic shelf label (ESL) device, a first beacon transmission including first encrypted address information; receive, from a second ESL device, a second beacon transmission including second encrypted address information; determine position information indicating a position of the device based on the first beacon transmission, the second beacon transmission, the first encrypted address information, the second encrypted address information, and the mapping information; and use the position information.

In a twenty-eight aspect, alone or in combination with the twenty-seventh aspect, the at least one processor is further configured to cause the device to: measure the first and second beacon transmissions to generate measurement information, when the position information is determined based the measurement information, and wherein the at least one processor configured to measure the first and second beacon transmissions includes to: calculate one or more of a received signal strength indicator (RSSI), a reference signal received power (RSRP), or an angle-of-arrival (AoA), of the first beacon transmission and the second beacon transmission; and determine the position information based on one or more of the RSSI, the RSRP, or the AoA of the first beacon transmission and the second beacon transmission.

In a twenty-ninth aspect, alone or in combination with the twenty-seventh or twenty-eighth aspects, the address mapping information correspond to association information which correlates an encrypted ESL radio address of an ESL beacon with a position and enables generation of the position information, and wherein the at least one processor is further configured to cause the device to: identify a first position of the first ESL device based on the first encrypted address information and the address mapping information; and identify a second position of the second ESL device based on the second encrypted address information and the address mapping information, and wherein the position information is determined based on the first position of the first ESL device and the second position of the second ESL device.

In a thirtieth aspect, alone or in combination with the twenty-seventh through twenty-ninth aspects, the at least one processor is further configured to cause the device to: transmit the position information to an ESL device; and receive a notification from the ESL device responsive to transmission of the position information.

Components, the functional blocks, and the modules described herein with respect to the figures described above include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented s electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein but are to be accorded the widest scope consistent with this disclosure, the principles and the novel features disclosed herein.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A device for wireless communication, comprising:
at least one processor; and
a memory coupled to the at least one processor,
wherein the at least one processor is configured to cause the device to:
receive, from an electronic shelf label (ESL) server, configuration information for position determination;
receive, from the ESL server, address generation information;
generate, address information based on the address generation information and the configuration information; and
transmit, to one or more ESL radios, a beacon start transmission including the address information, the beacon start transmission configured to cause one or more ESL devices to generate a corresponding encrypted dynamic address based on the address generation information and transmit a beacon indicating the corresponding encrypted dynamic address.

2. The device of claim 1, wherein the address generation information corresponds to a top level address associated with the device, and wherein the address information corresponds to a derived and encrypted address associated with the device.

3. The device of claim 1, wherein the configuration information includes or corresponds to information encryption information, dynamic address generation configuration information, or both.

4. The device of claim 1, wherein the address generation information includes or corresponds to a unique sequence value.

5. The device of claim 1, wherein the at least one processor is further configured to cause the device to:
receive, from the ESL server, second address generation information;
generate second address information based on the second address generation information and the configuration information, the second address information indicating a second address different from a first address indicated by the address information;
transmit, to one or more ESL radios, a second beacon start transmission including the second address information; and
transmit, to one or more ESL radios, a second beacon start transmission including the second address information, the second beacon start transmission configured to cause the one or more ESL devices to generate a corresponding second encrypted dynamic address based on the second address generation information and transmit a beacon indicating the corresponding second encrypted dynamic address.

6. A device for wireless communication, comprising:
at least one processor; and
a memory coupled to the at least one processor,
wherein the at least one processor is configured to cause the device to:
obtain configuration information for position determination;
receive, from an electronic shelf label (ESL) access point (AP), a beacon start transmission including address generation information;
generate, using encryption information, encrypted address information based on stored device specific information, the configuration information, and the address generation information; and
transmit the encrypted address information, the encrypted address information corresponding to a dynamic encrypted address, the encrypted address information configured to enable secure position determination.

7. The device of claim 6, wherein the address generation information corresponds to an encrypted address associated with the ESL AP, and wherein the encrypted address information corresponds to a derived and encrypted address associated with the device.

8. The device of claim 6, wherein the encrypted address information is generated based on the address generation information and based on time slot index information associated with the beacon start transmission.

9. The device of claim 6, wherein the at least one processor is further configured to cause the device to:
obtain a unique identifier for the device for an ESL system, and wherein the encrypted address information is generated further based on the unique identifier.

10. The device of claim 9, wherein the unique identifier is received in the beacon start transmission.

11. The device of claim 6, wherein the configuration information intentionally maps two ESL devices of an ESL system to a same address to garble ESL system addresses to outside devices.

12. The device of claim 6, wherein the at least one processor is further configured to cause the device to:
receive time varying key information from the ESL AP, and wherein the encrypted address information is generated further based on the time varying key information.

13. The device of claim 6, wherein the beacon start transmission is transmitted within a Bluetooth ESL synchronization packet.

14. The device of claim 6, wherein the beacon start transmission includes an ESL payload which includes one or more commands, wherein the one or more command comprises length command values (LCVs).

15. The device of claim 14, wherein each command of the one or more commands indicates address generation information for a particular ESL group.

16. The device of claim 14, wherein each command of the one or more commands indicates address generation information for a particular ESL device.

17. The device of claim 14, wherein each command of the one or more commands is associated with a particular ESL group and a particular device of the particular ESL group, and wherein each command of the one or more commands is arranged in an order which corresponds to an order of the corresponding associated device of the particular ESL group.

18. The device of claim 6, wherein the stored device specific information includes or corresponds to a public address or a static address associated with the device.

19. The device of claim 6, wherein the stored device specific information is a static address and corresponds to a medium access control (MAC) address of the device.

20. The device of claim 6, wherein the encrypted address information is further generated based on a private key received from the ESL AP or an ESL server.

21. The device of claim 6, wherein the encrypted address information changes each duty cycle or each beacon start transmission.

22. The device of claim 6, wherein the encryption information corresponds to a private key.

23. The device of claim 6, wherein the at least one processor is further configured to cause the device to:
receive, from the ESL AP, a second beacon start transmission including the address generation information;
generate, using the encryption information, second encrypted address information based on the stored device specific information and the address generation information; and
transmit the second encrypted address information, the second encrypted address information indicating a second address different from a first address indicated by the encrypted address information.

24. The device of claim 6, wherein the at least one processor is further configured to cause the device to:
receive, from the ESL AP, a second beacon start transmission including second address generation information different from the address generation information;
generate, using the encryption information, second encrypted address information based on the stored device specific information and the second address generation information; and
transmit the second encrypted address information, the second encrypted address information indicating a second address different from a first address indicated by the encrypted address information.

25. The device of claim 6, wherein the encryption information corresponds to Advanced Encryption Standard (AES) encryption information, and wherein the AES encryption information is used to perform AES encryption based on the stored device specific information and the address generation information to generate the encrypted address information.

26. The device of claim 6, wherein the encryption information corresponds to a random or pseudo-random sequence generator configured to perform random or pseudo-random encryption based on the stored device specific information and the address generation information to generate the encrypted address information.

27. A device for wireless communication, comprising:
at least one processor; and
a memory coupled to the at least one processor,
wherein the at least one processor is configured to cause the device to:
obtain address mapping information for position determination;
receive, from a first electronic shelf label (ESL) device, a first beacon transmission including first encrypted address information;
receive, from a second ESL device, a second beacon transmission including second encrypted address information;
determine position information indicating a position of the device based on the first beacon transmission, the second beacon transmission, the first encrypted address information, the second encrypted address information, and the address mapping information; and
use the position information.

28. The device of claim 27, wherein the at least one processor is further configured to cause the device to:
measure the first and second beacon transmissions to generate measurement information, when the position information is determined based the measurement information, and wherein the at least one processor configured to measure the first and second beacon transmissions includes to:
calculate one or more of a received signal strength indicator (RSSI), a reference signal received power (RSRP), or an angle-of-arrival (AoA), of the first beacon transmission and the second beacon transmission; and
determine the position information based on one or more of the RSSI, the RSRP, or the AoA of the first beacon transmission and the second beacon transmission.

29. The device of claim 27, wherein the address mapping information correspond to association information which correlates an encrypted ESL radio address of an ESL beacon with a position and enables generation of the position information, and wherein the at least one processor is further configured to cause the device to:
identify a first position of the first ESL device based on the first encrypted address information and the address mapping information; and
identify a second position of the second ESL device based on the second encrypted address information and the address mapping information, and wherein the position information is determined based on the first position of the first ESL device and the second position of the second ESL device.

30. The device of claim 27, wherein the at least one processor is further configured to cause the device to:
transmit the position information to an ESL device; and
receive a notification from the ESL device responsive to transmission of the position information.
